(19) United States
(12) Patent Application Publication
(10) Pub. No.: US 2016/0357529 A1
(43) Pub. Date: Dec. 8, 2016

(54) PARALLEL COMPUTING APPARATUS AND PARALLEL PROCESSING METHOD

(71) Applicant: FUJITSU LIMITED, Kawasaki-shi (JP)

(72) Inventor: YUJI TSUJIMORI, MISHIMA (JP)

(73) Assignee: FUJITSU LIMITED, Kawasaki-shi (JP)

(21) Appl. No.: 15/145,846

(22) Filed: May 4, 2016

(30) Foreign Application Priority Data
Jun. 2, 2015 (JP) 2015-112413

(51) Int. Cl. G06F 9/45

(52) U.S. Cl. CPC G06F 8/41

(57) ABSTRACT

Code includes a loop including update processing for updating elements of an array, indicated by a first index, and reference processing for referencing elements of the array, indicated by a second index. At least one of the first index and the second index depends on a parameter whose value is determined at runtime. A processor calculates, based on the value of the parameter determined at runtime, a first range of the elements to be updated by the update processing and a second range of the elements to be referenced by the reference processing prior to the execution of the loop. Then, the processor compares the first range with the second range and outputs a warning indicating that the loop is not parallelizable when the first range and the second range overlap in part.

### CROSS-REFERENCE TO RELATED APPLICATION

This application is based upon and claims the benefit of priority of the prior Japanese Patent Application No. 2015-112413, filed on Jun. 2, 2015, the entire contents of which are incorporated herein by reference.

### FIELD

The embodiments discussed herein are related to a parallel computing apparatus and a parallel processing method.

### BACKGROUND

Parallel computing apparatuses are sometimes employed, which run a plurality of threads in parallel using a plurality of processors (here including processing units called “processor cores”). One of parallel processes performed by such a parallel computing apparatus is loop parallelization. For example, it is considered to distribute, amongst iterations of a loop, the i^{th} iteration and the j^{th} iteration (i and j are different positive integers) between different threads and cause the threads to execute the individual iterations in parallel. However, when there is a dependency relationship between the i^{th} and j^{th} iterations of the loop, the semantics of the program after parallelizing the loop may be changed from one before the loop parallelization. This would be problematic especially when the loop includes an array update and an array reference and an array element updated in the i^{th} iteration and an array element referenced in the j^{th} iteration are the same. In this case, if the loop is parallelized, the execution order for the array update and reference is not guaranteed, which may cause unpredictable execution results and change the original semantics of the program. Therefore, it is preferable not to parallelize loops with such a dependency relationship.

On the other hand, in creating source code, a user may be able to explicitly specify parallelization of a loop. There are programming languages, such as FORTRAN, where parallel execution directives are defined by their language specifications. Apart from original language specifications, there are also extension languages, such as OpenMP, for adding parallel execution directives to the source code. Therefore, the user may mistakenly instruct parallelization of a loop for which parallelization is not desirable, thus producing an erroneous program.

To detect errors associated with loop parallelization, the following methods are available: static analysis performed by a compiler during converting source code into object code; and dynamic analysis by generating and executing debug object code. When array elements to be updated and those to be referenced inside a loop are statically identifiable from content of the source code, the compiler is able to statically detect errors. On the other hand, when array elements to be updated and those to be referenced depend on parameters whose values are determined at runtime, it is difficult to statically identify these elements from the content of the source code. In this case, a conceivable approach would be for the compiler to generate debug object code implementing a checking function and execute the debug object code to thereby detect errors dynamically.

For example, a compiler has been proposed which generates, from source code including a loop, debug object code to analyze if processing of the loop is allowed to run in parallel. The generated object code compares an index of an array element referenced when a loop variable is N1 with an index of an array element updated when the loop variable is N2, with respect to each of all combinations of N1 and N2. Then, if the two indexes match for at least one combination of N1 and N2, the loop is determined to be not parallelizable.

In addition, a compiler optimization method has been proposed. According to the proposed optimization method, a compiler checks whether two operations are independent (i.e., neither need the result of the other as an input) and, then, tries to parallelize the two operations when their independence from each other is proved. To check their independence, the compiler detects a loop described with an array X, a loop variable J, and constants a1, a2, b1, and b2. Assume that, in the loop, a reference to the array X using an index a1×J+b1 and a reference to the array X using an index a2×J+b2 are close to each other. In this case, the compiler examines the possibility that the two indexes point to the same element of the array X by calculating whether (a1−a2)×J+(b1−b2) takes 0 for some value of the loop variable J.

Japanese Laid-open Patent Publication No. 1-251274

Japanese Laid-open Patent Publication No. 5-197563

However, the technique disclosed in Japanese Laid-open Patent Publication No. 01-251274 exhaustively calculates specific combinations of index values used for an array update and for an array reference. That is, multiple loops are executed to thereby calculate all the specific combinations of an array element to be updated and an array element to be referenced. Therefore, the conventional technique has the problem of heavy examination load. In the case of performing examinations sequentially in the original loop, it is difficult to parallelize the loop while implementing the checking function. Therefore, there remains the problem of the runtime of debug object code implementing the checking function being significantly long compared to the runtime of original object code without the checking function.

### SUMMARY

According to an aspect, there is provided a parallel computing apparatus including a memory and a processor. The memory is configured to store code including a loop which includes update processing for updating first elements of an array, indicated by a first index, and reference processing for referencing second elements of the array, indicated by a second index. At least one of the first index and the second index depends on a parameter whose value is determined at runtime. The processor is configured to perform a procedure including calculating, based on the value of the parameter determined at runtime, a first range of the first elements to be updated in the array by the update processing and a second range of the second elements to be referenced in the array by the reference processing prior to execution of the loop after execution of the code has started; and comparing the first range with the second range and outputting a warning indicating that the loop is not parallelizable when the first range and the second range overlap in part.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a parallel computing device according to a first embodiment;

FIG. 2 illustrates a compiling apparatus according to a second embodiment;

FIG. 3 illustrates an information processing system according to a third embodiment;

FIG. 4 is a block diagram illustrating an example of hardware of a parallel computing device;

FIG. 5 is a block diagram illustrating an example of hardware of a compiling device;

FIGS. 6A to 6C are a first set of diagrams illustrating source code examples;

FIGS. 7A to 7C are a first set of diagrams illustrating relationship examples between a definition region and a reference region;

FIGS. 8A to 8C are a second set of diagrams illustrating source code examples;

FIGS. 9A to 9C are a second set of diagrams illustrating relationship examples between the definition region and the reference region;

FIGS. 10A to 10C are a third set of diagrams illustrating source code examples;

FIGS. 11A to 11C are a third set of diagrams illustrating relationship examples between the definition region and the reference region;

FIGS. 12A and 12B are a fourth set of diagrams illustrating source code examples;

FIGS. 13A and 13B are a fifth set of diagrams illustrating source code examples;

FIGS. 14A and 14B are a fourth set of diagrams illustrating relationship examples between the definition region and the reference region;

FIGS. 15A and 15B are a fifth set of diagrams illustrating relationship examples between the definition region and the reference region;

FIG. 16 is a sixth diagram illustrating a source code example;

FIG. 17 is a block diagram illustrating an example of functions of the parallel computing device and the compiling device;

FIG. 18 illustrates an example of parameters for a library call;

FIG. 19 illustrates a display example of an error message;

FIG. 20 is a flowchart illustrating a procedure example of compilation;

FIG. 21 is a flowchart illustrating a procedure example of pre-loop analysis;

FIG. 22 is a flowchart illustrating a procedure example of analysis of continuous-to-continuous regions;

FIG. 23 is a flowchart illustrating a procedure example of analysis of continuous-to-regularly spaced regions;

FIG. 24 is a flowchart illustrating a procedure example of analysis of regularly spaced-to-continuous regions;

FIG. 25 is a flowchart illustrating a procedure example of analysis of regularly spaced-to-regularly spaced regions;

FIG. 26 is a flowchart illustrating a procedure example of in-loop analysis;

FIG. 27 is a flowchart illustrating a procedure example of individual definition analysis; and

FIG. 28 is a flowchart illustrating a procedure example of individual reference analysis.

### DESCRIPTION OF EMBODIMENTS

Several embodiments will be described below with reference to the accompanying drawings, wherein like reference numerals refer to like elements throughout.

### (a) First Embodiment

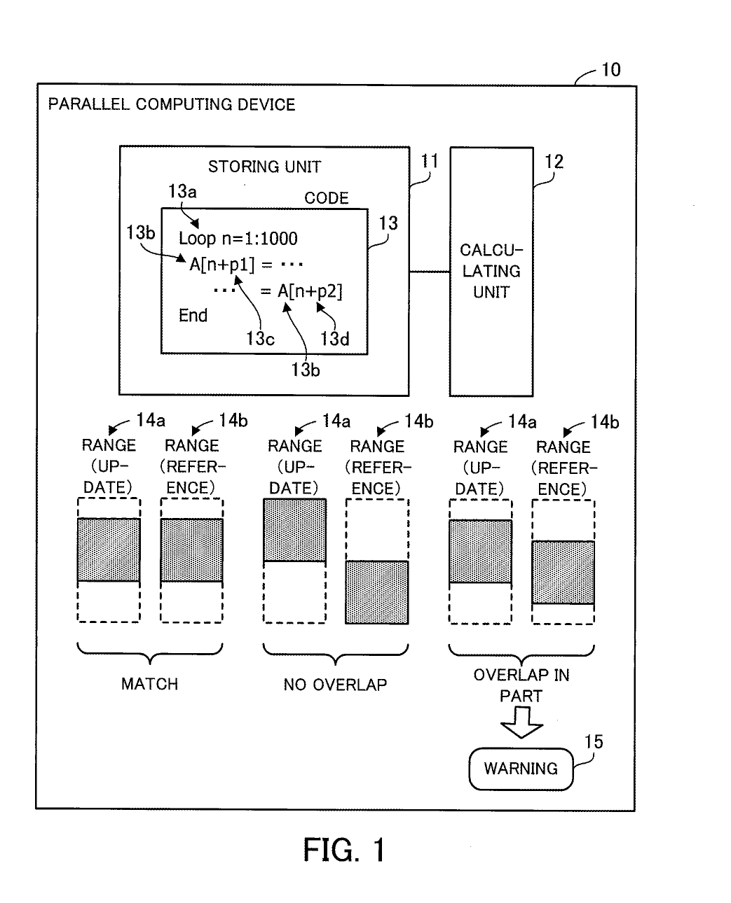

A first embodiment will now be described below. FIG. 1 illustrates a parallel computing device according to the first embodiment. A parallel computing device 10 of the first embodiment is a shared memory multiprocessor with a plurality of processors (including processing units called processor cores) and a shared memory. Using the processors, the parallel computing device 10 is able to run a plurality of threads in parallel. These threads are allowed to use the shared memory. The parallel computing device 10 may be a client computer operated by a user, or a server computer accessed from a client computer.

The parallel computing device 10 includes a storing unit 11 and a calculating unit 12. The storing unit 11 may be a volatile semiconductor memory such as random access memory (RAM), or a non-volatile storage device such as a hard disk drive (HDD) or flash memory. The storing unit 11 may be the above-described shared memory. The calculating unit 12 is, for example, a central processing unit (CPU), a CPU core, or a digital signal processor (DSP). The calculating unit 12 may be a processor for executing one of the threads described above. The calculating unit 12 executes programs stored in a memory, for example, the storing unit 11. The programs to be executed include a parallel processing program.

The storing unit 11 stores therein code 13. The code 13 is, for example, object code compiled in such a manner that the processors of the parallel computing device 10 are able to execute it. The code 13 includes a loop 13a. The loop 13a includes update processing for updating elements of an array 13b (array A), indicated by an index 13c (first index). The loop 13a also includes reference processing for referencing elements of the array 13b, indicated by an index 13d (second index). The indexes 13c and 13d are sometimes called “subscripts”.

The indexes 13c and 13d depend on a loop variable controlling iterations of the loop 13a. For example, each of the indexes 13c and 13d includes a loop variable n. In addition, at least one of the indexes 13c and 13d depends on a parameter whose value is determined at runtime. Such parameters may be called “variables” or “arguments”. The parameters are, for example, variables each of whose value is determined by the start of the execution of the loop and remains unchanged within the loop. The parameters may be variables defining the value range of the loop variable, such as an upper bound, a lower bound, and a step size of the loop variable. Such a parameter may be included in at least one of the indexes 13c and 13d. According to the example of FIG. 1, the index 13c includes a parameter p1 and the index 13d includes a parameter p2. Because the parameters p1 and p2 are determined at runtime, it is difficult to statically calculate the value ranges of the indexes 13c and 13d.

The calculating unit 12 starts the execution of the code 13 stored in the storing unit 11. Immediately before the execution of the loop 13a, the calculating unit 12 performs parallelization analysis to determine whether the loop 13a is parallelizable. If the loop 13a is determined to be parallelizable, the parallel computing device 10 may execute iterations of the loop 13a in parallel using the plurality of processors (which may include the calculating unit 12). On the other hand, if the loop 13a is determined to be not parallelizable, the calculating unit 12 outputs a warning 15 indicating that the loop 13a is not parallelizable. The calculating unit 12 stores a message of the warning 15 in the storing unit 11 or a different storage device, for example, as a log. In addition, the calculating unit 12 displays the message of the warning 15, for example, on a display connected to the parallel computing device 10.

In the parallelization analysis, the calculating unit 12 calculates a range 14a (first range) and a range 14b (second range) based on values of the parameters, determined at runtime. The range 14a is, amongst a plurality of elements included in the array 13b, a range of elements to be updated throughout the entire iterations of the loop 13a (i.e., during the period from the start to the end of the loop 13a). The range 14b is, amongst the plurality of elements included in the array 13b, a range of elements to be referenced throughout the entire iterations of the loop 13a. The ranges 14a and 14b may be identified using addresses each indicating a storage area in memory (i.e., memory addresses), allocated to the array 13b.

For example, the calculating unit 12 calculates the ranges 14a and 14b based on the lower bound, the upper bound, and the step size (an increment in the value of the loop variable after each iteration) of the loop variable, the data size of each element of the array 13b, and values of other parameters. At least one of the ranges 14a and 14b may be a set of consecutive elements amongst the plurality of elements included in the array 13b, or a continuous storage area in the memory. In addition, at least one of the ranges 14a and 14b may be a set of elements regularly spaced amongst the elements included in the array 13b, or storage areas regularly spaced within the memory. The state of “a plurality of elements or storage areas being regularly spaced” includes a case where the elements or storage areas are spaced at predetermined intervals.

Then, the calculating unit 12 compares the calculated ranges 14a and 14b with each other. If the ranges 14a and 14b partially overlap (i.e., if some elements overlap and others do not overlap), the calculating unit 12 determines that the loop 13a is not parallelizable. Then, the calculating unit 12 outputs the warning 15 indicating that the loop 13a is not parallelizable. On the other hand, if the ranges 14a and 14b overlap in full, the calculating unit 12 may determine that the loop 13a is parallelizable. If the ranges 14a and 14b do not overlap (i.e., if no overlap in elements is observed between the ranges 14a and 14b), the calculating unit 12 may determine that the loop 13a is parallelizable. Note that the above-described parallelization analysis performed by the calculating unit 12 may be implemented as a library program. In that case, a call statement to call the library program may be inserted by a compiler immediately before the loop 13a in the code 13.

According to the parallel computing device 10 of the first embodiment, prior to the execution of the loop 13a, the range 14a of elements to be updated and the range 14b of elements to be referenced in the array 13b are calculated based on parameter values determined at runtime. Then, prior to the execution of the loop 13a, the parallel computing device 10 compares the ranges 14a and 14b with each other, and outputs the warning 15 indicating that the loop 13a is not parallelizable if the ranges 14a and 14b overlap in part.

As described above, even when a parameter whose value is determined at runtime is present, it is possible to determine before the execution of the loop 13a whether the loop 13a is parallelizable. When the loop 13a is determined to be parallelizable, a plurality of threads are allowed to run to thereby execute the iterations of the loop 13a in parallel. On the other hand, in the case of analyzing the values of the indexes 13c and 13d inside the loop 13a (i.e., while the loop 13a is in progress), it is difficult to parallelize the loop 13a due to the analysis. According to the first embodiment, there is no impediment to the parallelization of the loop 13a, thus needing less time to run the loop 13a. In addition, compared to the technique of calculating all specific combinations of values of the indexes 13c and 13d by executing multiple loops, the first embodiment is able to reduce load of the parallelization analysis. This leads to efficiently detecting, in the code 13, errors associated with parallelization of the loop 13a, which in turn improves the efficiency of the execution of the code 13.

### (b) Second Embodiment

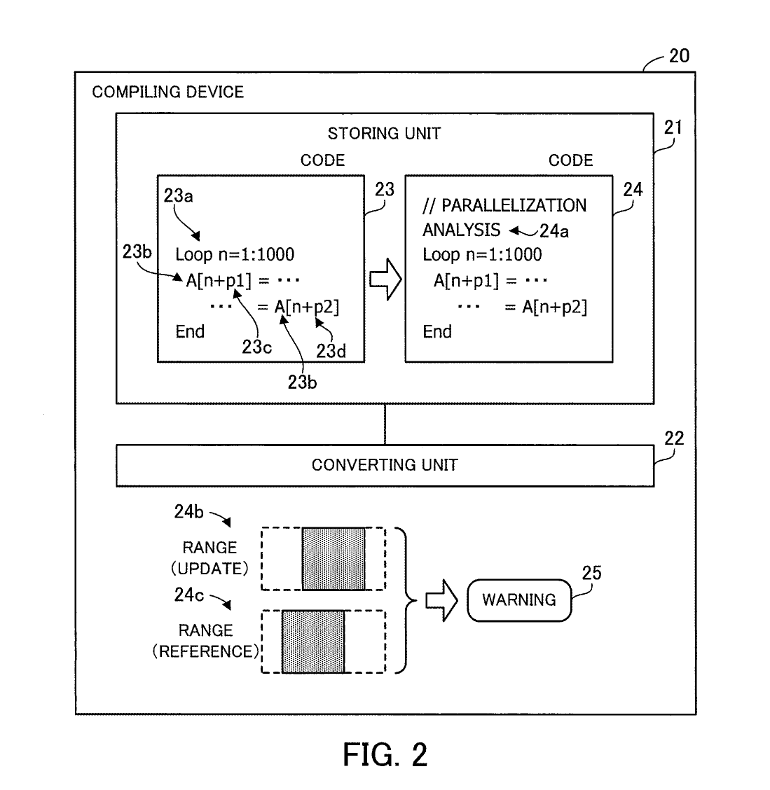

A second embodiment will now be described below. FIG. 2 illustrates a compiling apparatus according to the second embodiment. A compiling device 20 according to the second embodiment generates code to be executed by a computer with parallel processing capability, like the parallel computing device 10 of the first embodiment. The compiling device 20 may be a computer for executing a compiler implemented as software. The compiling device 20 may be a client computer operated by a user, or a server computer accessed from a client computer. The compiling device 20 includes a storing unit 21 and a converting unit 22. The storing unit 21 may be a volatile semiconductor memory such as RAM, or a non-volatile storage device such as a HDD or flash memory. The converting unit 22 is a processor such as a CPU or a DSP. The converting unit 22 executes programs stored in a memory, for example, the storing unit 21. The programs to be executed include a compiler.

The storing unit 21 stores code 23 (first code). The code 23 may be source code created by a user, intermediate code converted from source code, or object code converted from source code or intermediate code. The storing unit 21 also stores code 24 (second code) converted from the code 23. The code 24 may be source code, intermediate code, or object code. Note that the codes 23 and 24 may be called “programs” or “instruction sets”.

The code 23 includes a loop 23a. The loop 23a includes update processing for updating elements of an array 23b, indicated by an index 23c (first index). The loop 23a also includes reference processing for referencing elements of the array 23b, indicated by an index 23d (second index). At least one of the indexes 23c and 23d depends on a parameter whose value is determined at runtime. The loop 23a corresponds to the loop 13a of the first embodiment. The array 23b corresponds to the array 13b of the first embodiment. The indexes 23c and 23d correspond to the indexes 13c and 13d of the first embodiment. The code 24 has a function of examining whether the loop 23a is parallelizable. The code 24 may be called “debug code”. The compiling device 20 may convert the code 23 into the code 24 only when a predetermined option (for example, debug option) is attached to a compile command input by the user.

The converting unit 22 detects the loop 23a in the code 23. The loop 23a to be detected may be a loop for which a parallelization instruction has been issued by the user. The converting unit 22 extracts, from the loop 23a, an update instruction for the array 23b and a reference instruction for the array 23b. Because at least one of the indexes 23c and 23d depends on a parameter, it is difficult to statically determine whether the same elements are to be updated and then referenced throughout the entire iterations of the loop 23a (i.e., during the period from the start to the end of the loop 23a). In view of this, the converting unit 22 generates the code 24 from the code 23 in such a manner that parallelization analysis 24a is performed immediately before the execution of the loop 23a. For example, the converting unit 22 inserts an instruction for parallelization analysis immediately before the loop 23a. Alternatively, the converting unit 22 may insert a call statement for calling a library for parallelization analysis immediately before the loop 23a.

The parallelization analysis 24a includes calculating a range 24b of elements to be updated (first range) in the array 23b and a range 24c of elements to be referenced (second range) in the array 23b based on parameter values determined at runtime. The ranges 24b and 24c correspond to the ranges 14a and 14b, respectively, of the first embodiment. The parallelization analysis 24a also includes comparing the ranges 24b and 24c with each other and outputting a warning 25 indicating that the loop 23a is not parallelizable if the ranges 24b and 24c overlap in part. The warning 25 corresponds to the warning 15 of the first embodiment.

The compiling device 20 of the second embodiment detects the loop 23a in the code 23 and converts the code into the code 24 in such a manner that the parallelization analysis 24a for examining whether the loop 23a is parallelizable is performed prior to the execution of the loop 23a. In the parallelization analysis 24a, the range 24b to be updated and the range 24c to be referenced are calculated based on the parameter values determined at runtime and the warning is output if the ranges 24b and 24c overlap in part.

Herewith, even when it is difficult to statically determine at the time of compilation whether the loop 23a is parallelizable, it is possible to generate the code 24 for dynamically determining the parallelizability at runtime. Then, when the loop 23a is determined to be parallelizable, iterations of the loop 23a are allowed to be executed in parallel. Therefore, there is no impediment to the parallelization of the loop 23a, thus needing less time to run the loop 23a. In addition, the parallelization analysis 24a is performed before the execution of the loop 23a, thus reducing analysis load. This leads to efficiently detecting, in the code 23, errors associated with parallelization of the loop 23a.

### (c) Third Embodiment

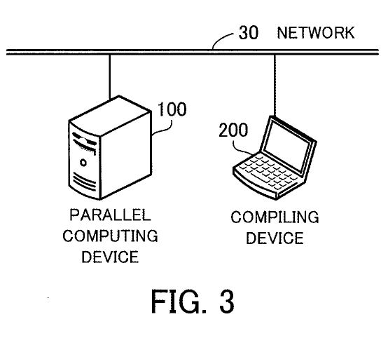

A third embodiment will now be described below. FIG. 3 illustrates an information processing system according to the third embodiment. The information processing system according to the third embodiment includes a parallel computing device 100 and a compiling device 200. The parallel computing device 100 and the compiling device 200 are connected via a network 30. Each of the parallel computing device 100 and the compiling device 200 may be a client computer operated by a user, or a server computer accessed from a client computer via the network 30. Note that the parallel computing device 100 corresponds to the parallel computing device 10 of the first embodiment. The compiling device 200 corresponds to the compiling device 20 of the second embodiment.

The parallel computing device 100 is a shared memory multiprocessor capable of executing a plurality of threads in parallel using a plurality of CPU cores. The compiling device 200 converts source code created by the user into object code executable by the parallel computing device 100. In this regard, the compiling device 200 is able to generate, from the source code, parallel-process object code capable of starting a plurality of threads that operate in parallel. The generated object code is transmitted from the compiling device 200 to the parallel computing device 100. According to the third embodiment, the device for compiling a program and the device for executing the program are provided separately; however, these may be provided as a single device.

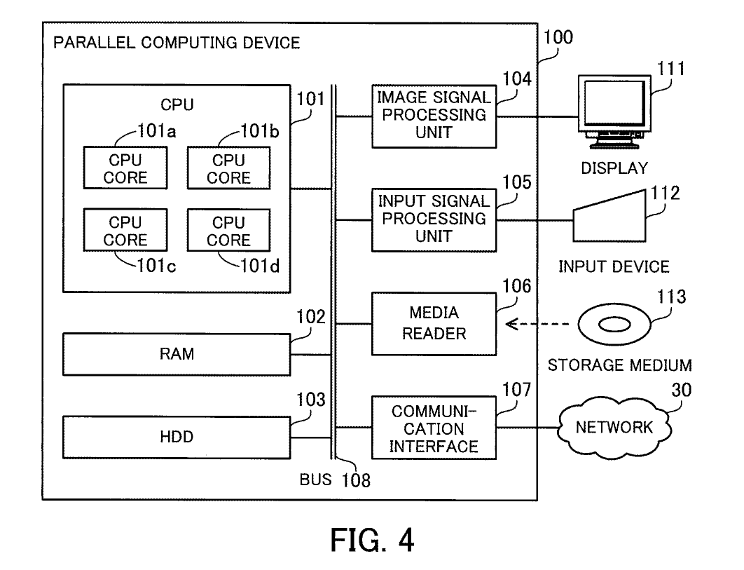

FIG. 4 is a block diagram illustrating an example of hardware of the parallel computing device. The parallel computing device 100 includes a CPU 101, a RAM 102, a HDD 103, an image signal processing unit 104, an input signal processing unit 105, a media reader 106, and a communication interface 107. These units are connected to a bus 108. The CPU 101 is a processor for executing program instructions. The CPU 101 loads at least part of a program and data stored in the HDD 103 into the RAM 102 to execute the program. The CPU 101 includes CPU cores 101a to 101d capable of running threads in parallel. Note here that the number of CPU cores of the CPU 101 is not limited to four as in this example, and the CPU 101 may include two or more CPU cores. Note also that each of the CPU cores 101a to 101d may be referred to as a “processor”, or a set of the CPU cores 101a to 101d or the CPU 101 may be referred to as a “processor”.

The RAM 102 is a volatile semiconductor memory for temporarily storing therein programs to be executed by the CPU 101 and data to be used by the CPU 101 for its computation. Note that the parallel computing device 100 may be provided with a different type of memory other than RAM, or may be provided with a plurality of memory devices. The HDD 103 is a non-volatile storage device for storing therein software programs, such as an operating system (OS), middleware, and application software, as well as various types of data. The programs include ones compiled by the compiling device 200. Note that the parallel computing device 100 may be provided with a different type of storage device, such as a flash memory or solid state drive (SSD), or may be provided with a plurality of non-volatile storage devices.

The image signal processing unit 104 outputs an image on a display 111 connected to the parallel computing device 100 according to an instruction from the CPU 101. Various types of displays including the following may be used as the display 111: a cathode ray tube (CRT) display; a liquid crystal display (LCD); a plasma display panel (PDP); and an organic electro-luminescence (OEL) display.

The input signal processing unit 105 acquires an input signal from an input device 112 connected to the parallel computing device 100 and outputs the input signal to the CPU 101. Various types of input devices including the following may be used as the input device 112: a pointing device, such as a mouse, touch panel, touch-pad, or trackball; a keyboard; a remote controller; and a button switch. In addition, the parallel computing device 100 may be provided with a plurality of types of input devices.

The media reader 106 is a reader for reading programs and data recorded in a storage medium 113. As the storage medium 113, any of the following may be used: a magnetic disk, such as a flexible disk (FD) or HDD; an optical disk, such as a compact disc (CD) or digital versatile disc (DVD); a magneto-optical disk (MO); and a semiconductor memory. The media reader 106 stores programs and data read from the storage medium 113, for example, in the RAM 102 or the HDD 103. The communication interface 107 is connected to the network 30 and communicates with other devices, such as the compiling device 200, via the network 30. The communication interface 107 may be a wired communication interface connected via a cable to a communication apparatus, such as a switch, or a wireless communication interface connected via a wireless link to a base station.

Note that the parallel computing device 100 may not be provided with the media reader 106, and further may not be provided with the image signal processing unit 104 and the input signal processing unit 105 in the case where these functions are controllable from a terminal operated by a user. In addition, the display 111 and the input device 112 may be integrally provided on the chassis of the parallel computing device 100. The CPU 101 corresponds to the calculating unit 12 of the first embodiment. The RAM 102 corresponds to the storing unit 11 of the first embodiment.

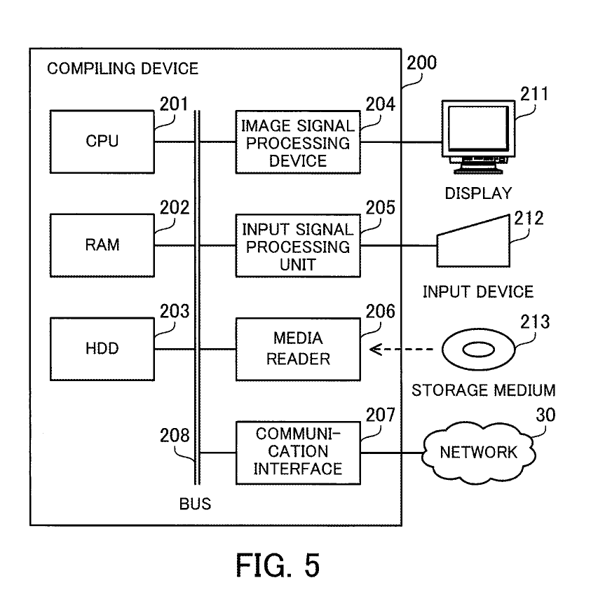

FIG. 5 is a block diagram illustrating an example of hardware of the compiling device. The compiling device 200 includes a CPU 201, a RAM 202, a HDD 203, an image signal processing unit 204, an input signal processing unit 205, a media reader 206, and a communication interface 207. These units are connected to a bus 208. The CPU 201 has the same functions as the CPU 101 of the parallel computing device 100. Note however that the CPU 201 may have a single CPU core and, thus, the CPU 201 may not be a multiprocessor. The RAM 202 and the HDD 203 have the same functions as the RAM 102 and the HDD 103, respectively, of the parallel computing device 100. Note however that programs stored in the HDD 203 include a compiler.

The image signal processing unit 204 has the same function as the image signal processing unit 104 of the parallel computing device 100. The image signal processing unit 204 outputs an image to a display 211 connected to the compiling device 200. The input signal processing unit 205 has the same function as the input signal processing unit 105 of the parallel computing device 100. The input signal processing unit 205 acquires an input signal from an input device 212 connected to the compiling device 200. The media reader 206 has the same functions as the media reader 106 of the parallel computing device 100. The media reader 206 reads programs and data recorded in a storage medium 213. Note that the storage media 113 and 213 may be the same medium. The communication interface 207 has the same functions as the communication interface 107 of the parallel computing device 100. The communication interface 207 is connected to the network 30.

Note that the compiling device 200 may not be provided with the media reader 206, and further may not be provided with the image signal processing unit 204 and the input signal processing unit 205 in the case where these functions are controllable from a terminal operated by the user. In addition, the display 211 and the input device 212 may be integrally provided on the chassis of the parallel computing device 200. The CPU 201 corresponds to the converting unit 22 of the second embodiment. The RAM 202 corresponds to the storing unit 21 of the second embodiment.

Next described is loop parallelizability. Source code created by a user may include a parallel directive indicating execution of iterations of a loop in parallel using a plurality of threads. The third embodiment is mainly directed to the case where the parallel directive is defined by a specification of a programming language. If the parallel directive is included in the source code, the compiling device 200 generates, in principle, object code to execute iterations of a loop in parallel according to an instruction of the user. That is, amongst the iterations of the loop, the i^{th} iteration and the j^{th} iteration (i and j are different positive integers) are executed by different threads individually running on different CPU cores.

In this regard, however, when both storage of values in an array (“definition”) and acquisition of values from the array (“reference”) take place in the loop, a dependency relationship may exist between the i^{th} iteration and the j^{th} iteration. The dependency relationship arises when an array element defined in the i^{th} iteration is the same as that referenced in the j^{th} iteration. If the loop with the iterations in a dependency relationship is parallelized, the execution order for the array definition and reference is not guaranteed and, therefore, the loop parallelization may cause unpredictable processing results. For this reason, source code including a parallel directive for a loop with iterations in a dependency relationship is said to be semantically wrong.

Whether there is a dependency relationship between iterations depends on a relationship between a value range of an index (a subscript of the array) used for a definition and a value range of an index used for a reference. In the case where the lower bound, upper bound, and step size of a loop variable, which controls iterations of the loop, are constants and both the two indexes depend only on the loop variable, the compiling device 200 is able to statically identify the value ranges of the two indexes at the time of compilation. In this case, the compiling device 200 is able to statically determine at the time of compilation whether the loop is parallelizable.

A comparison is made, within a memory region for storing the array, between a region to be defined throughout the entire iterations of the loop (definition region) and a region to be referenced throughout the entire iterations of the loop (reference region). When the definition region and the reference region perfectly match each other, a dependency relationship is less likely to exist between the i^{th} iteration and the j^{th} iteration although a dependency relationship may arise between the definition and the reference within the i^{th} iteration. Therefore, when the two regions perfectly match, the loop is determined to be parallelizable. In addition, also when the definition region and the reference region have no overlap, the loop is determined to be parallelizable. On the other hand, when the definition region and the reference region overlap in part, an element is likely to be defined in the i^{th} iteration and then referenced in the j^{th} iteration. For this reason, when the two regions overlap in part, the loop is determined to be not parallelizable.

When the index used for an array definition and the index used for an array reference do not depend on a variable other than the loop variable, the loop parallelizability is statically determined at the time of compilation. On the other hand, when at least one of the index used for an array definition and the index used for an array reference depends on a variable other than the loop variable, it is difficult to statically determine at the time of compilation whether the loop is parallelizable. The variable other than the loop variable may indicate the lower bound, upper bound, or step size of the loop variable. In addition, such a variable other than the loop variable may be included in the indexes. The value of the variable other than the loop variable is usually determined before the execution of the loop and remains unchanged within the loop. In this case, the compiling device 200 generates debug object code for dynamically determining at runtime whether the loop is parallelizable. The debug object code is generated only when a debug option is attached to a compile command.

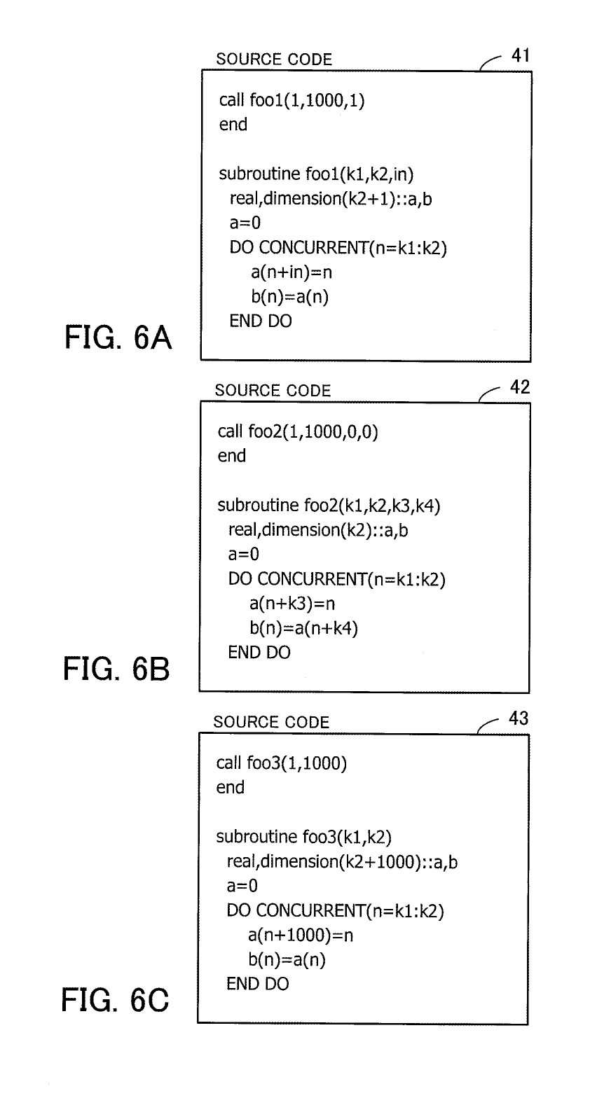

Next described are examples of comparison between the definition region and the reference region. FIGS. 6A to 6C are a first set of source code examples. Source code 41 contains subroutine foo1. Subroutine foo1 takes k1, k2, and in as arguments. Subroutine foo1 defines a real array a with a length of k2+1. Subroutine foo1 executes a loop while increasing the value of a loop variable n by 1 from k1 to k2. A parallel directive “CONCURRENT” instructs the loop to be executed in parallel. The loop includes definition processing for defining the (n+in)^{th} elements of the array a and reference processing for referencing the n^{th} elements of the array a. The definition region and the reference region in the array a depend on the arguments k1, k2, and in whose values are determined at runtime. The source code 41 contains a call statement to call subroutine foo1 with designation of k1=1, k2=1000, and in=1 as arguments.

Source code 42 contains subroutine foo2. Subroutine foo2 takes k1, k2, k3, and k4 as arguments. Subroutine foo2 executes a loop while increasing the value of the loop variable n by 1 from k1 to k2. The loop includes definition processing for defining the (n+k3)^{th} elements of the array a and reference processing for referencing the (n+k4)^{th} elements of the array a. The definition region and the reference region in the array a depend on the arguments k1, k2, k3, and k4 whose values are determined at runtime. The source code 42 contains a call statement to call subroutine foo2 with designation of k1=1, k2=1000, k3=0, and k4=0 as arguments.

Source code 43 contains subroutine foo3. Subroutine foo3 takes k1 and k2 as arguments. Subroutine foo3 executes a loop while increasing the value of the loop variable n by 1 from k1 to k2. The loop includes definition processing for defining the (n+1000)^{th} elements of the array a and reference processing for referencing the n^{th} elements of the array a. The definition region and the reference region in the array a depend on the arguments k1 and k2 whose values are determined at runtime. The source code 43 contains a call statement to call subroutine foo3 with designation of k1=1 and k2=1000 as arguments.

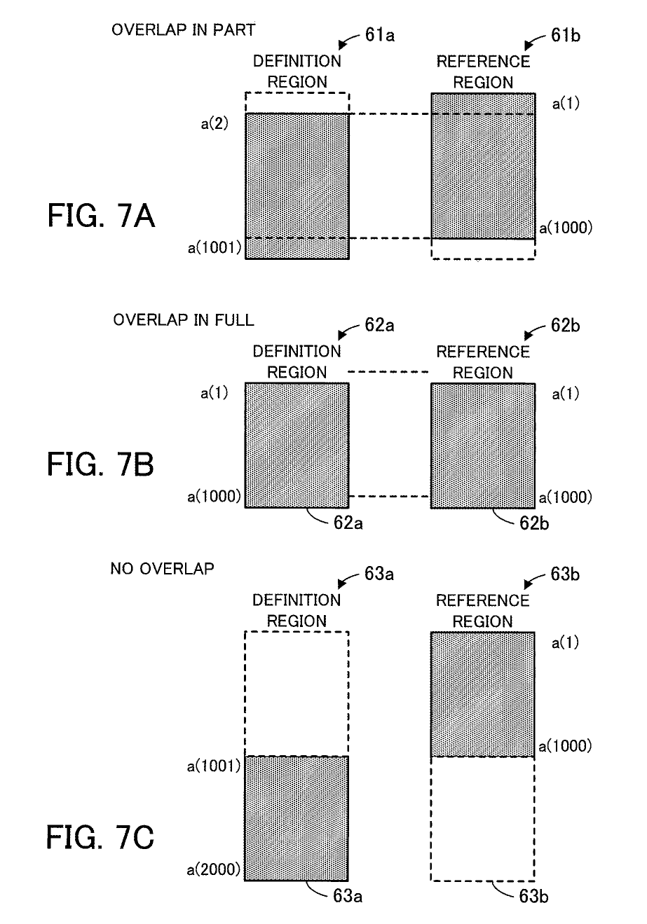

FIGS. 7A to 7C are a first set of diagrams illustrating relationship examples between the definition region and the reference region. A definition region 61a is defined based on the loop in the source code 41. Specifically, the definition region 61a is a continuous region extending from a(2) to a(1001). A reference region 61b is referenced based on the loop in the source code 41. Specifically, the reference region 61b is a continuous region extending from a(1) to a(1000). By comparing the definition region 61a with the reference region 61b, it is seen that the two regions overlap from a(2) to a(1000) but do not overlap at a(1) and a(1001). That is, the definition region 61a and the reference region 61b overlap in part. Therefore, the loop in the source code 41 is not parallelizable and the source code 41 is, therefore, semantically wrong.

A definition region 62a is defined based on the loop in the source code 42. Specifically, the definition region 62a is a continuous region extending from a(1) to a(1000). A reference region 62b is referenced based on the loop in the source code 42. Specifically, the reference region 62b is a continuous region extending from a(1) to a(1000). By comparing the definition region 62a with the reference region 62b, it is seen that the two regions overlap in full. Therefore, the loop in the source code 42 is parallelizable and the source code 42 is, therefore, semantically correct.

A definition region 63a is defined based on the loop in the source code 43. Specifically, the definition region 63a is a continuous region extending from a(1001) to a(2000). A reference region 63b is referenced based on the loop in the source code 43. Specifically, the reference region 63b is a continuous region extending from a(1) to a(1000). By comparing the definition region 63a with the reference region 63b, it is seen that the two regions have no overlap. Therefore, the loop in the source code 43 is parallelizable and the source code 43 is, therefore, semantically correct.

The definition region 61a and the reference region 61b are calculated from the arguments k1, k2, and in. Therefore, the parallel computing device 100 is able to calculate, before the execution of the loop, the definition region 61a and the reference region 61b to thereby determine that the loop is not parallelizable. In a similar fashion, the definition region 62a and the reference region 62b are calculated from the arguments k1, k2, k3, and k4. Therefore, the parallel computing device 100 is able to calculate, before the execution of the loop, the definition region 62a and the reference region 62b to thereby determine that the loop is parallelizable. In addition, the definition region 63a and the reference region 63b are calculated from the arguments k1 and k2. Therefore, the parallel computing device 100 is able to calculate, before the execution of the loop, the definition region 63a and the reference region 63b to thereby determine that the loop is parallelizable. Thus, when the definition and reference regions are individually continuous regions, it is possible to determine before the execution of a loop whether the loop is parallelizable.

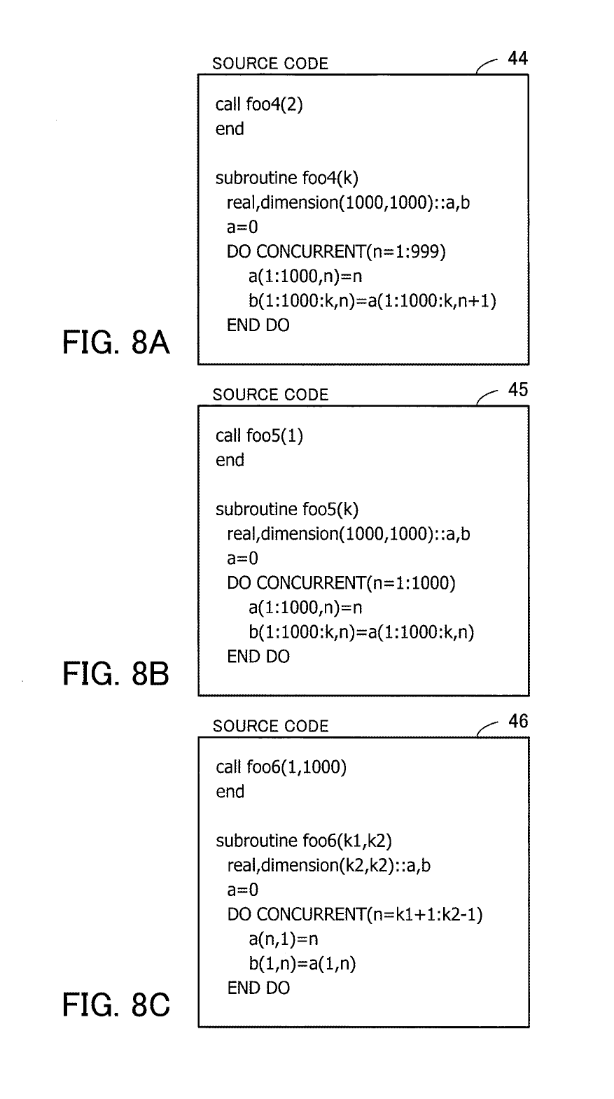

FIGS. 8A to 8C are a second set of diagrams illustrating source code examples. Source code 44 contains subroutine foo4. Subroutine foo4 takes k as an argument. Subroutine foo4 defines a two-dimensional real array a of 1000×1000. Subroutine foo4 executes a loop while increasing the value of the loop variable n by 1 from 1 to 999. The loop includes definition processing for defining elements in a range (1, n) to (1000, n) of the two-dimensional array a. The loop also includes reference processing for referencing elements in a range (1, n+1) to (1000, n+1) of the two-dimensional array a. Note however that the elements to be referenced are selected at the rate of one for every k elements. Thus, the reference region of the two-dimensional array a depends on the argument k whose value is determined at runtime. The source code 44 contains a call statement to call subroutine foo4 with designation of k=2 as an argument.

Source code 45 contains subroutine foo5. Subroutine foo5 takes k as an argument. Subroutine foo5 executes a loop while increasing the value of the loop variable n by 1 from 1 to 1000. The loop includes definition processing for defining elements in the range (1, n) to (1000, n) of the two-dimensional array a. The loop also includes reference processing for referencing elements in the range (1, n) to (1000, n) of the two-dimensional array a. Note however that the elements to be referenced are selected at the rate of one for every k elements. Thus, the reference region of the two-dimensional array a depends on the argument k whose value is determined at runtime. The source code 45 contains a call statement to call subroutine foo5 with designation of k=1 as an argument.

Source code 46 contains subroutine foo6. Subroutine foo6 takes k1 and k2 as arguments. Subroutine foo6 executes a loop while increasing the value of the loop variable n by 1 from k1+1 to k2−1. The loop includes definition processing for defining elements (n, 1) of the two-dimensional array a and reference processing for referencing elements (1, n) of the two-dimensional array a. The definition and reference regions of the two-dimensional array a depend on the arguments k1 and k2 whose values are determined at runtime. The source code 46 contains a call statement to call subroutine foo6 with designation of k1=1 and k2=1000 as arguments.

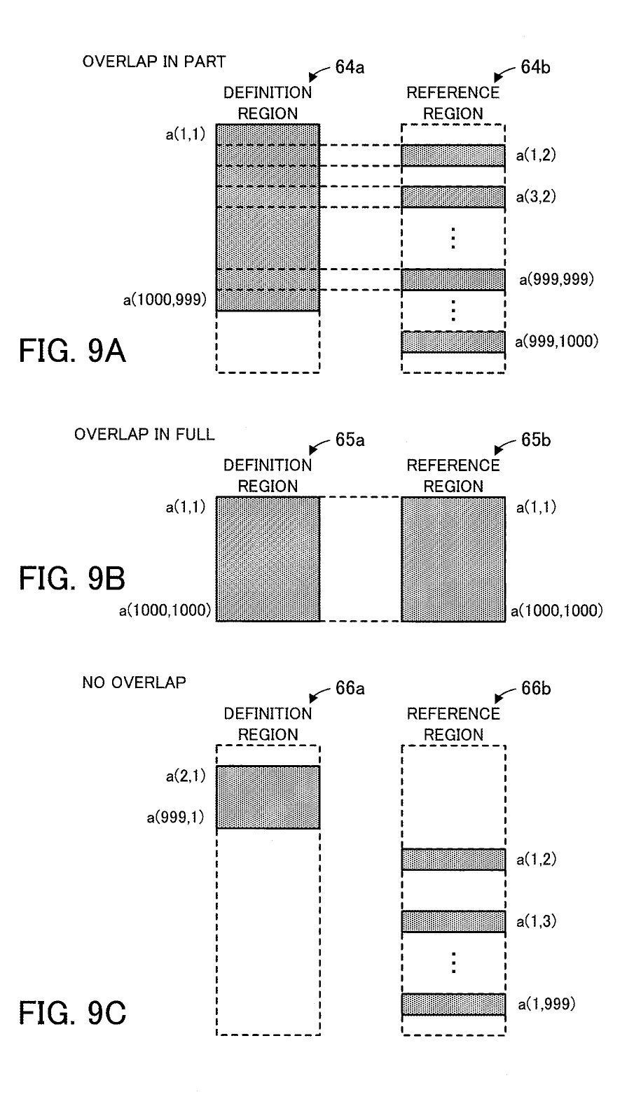

FIGS. 9A to 9C are a second set of diagrams illustrating relationship examples between the definition region and the reference region. Elements of the two-dimensional array are arranged in a memory in the order of (1, 1), (2, 1), . . . , (1000, 1), (1, 2), (2, 2), . . . , (1000, 2), and so on. That is, elements with the second dimensional index being the same and the first dimensional index being different from one another are arranged in a continuous memory region. A definition region 64a is defined based on the loop in the source code 44. Specifically, the definition region 64a is a continuous region extending from a(1, 1) to a(1000, 999). A reference region 64b is referenced based on the loop in the source code 44. Specifically, the reference region 64b is a collection of regions spaced at regular intervals like a(1, 2), a(3, 2), . . . , a(999, 999), . . . , and a(999, 1000). By comparing the definition region 64a with the reference region 64b, a(1, 2), . . . , and a(999, 999) of the reference region 64b overlap the definition region 64a. On the other hand, a(1, 1000), . . . , and a(999, 1000) of the reference region 64b do not overlap the definition region 64a. That is, the definition region 64a and the reference region 64b overlap in part. Therefore, the loop in the source code 44 is not parallelizable and the source code 44 is, therefore, semantically wrong.

A definition region 65a is defined based on the loop in the source code 45. Specifically, the definition region 65a is a continuous region extending from a(1, 1) to a(1000, 1000). A reference region 65b is referenced based on the loop in the source code 45. Specifically, the reference region 65b is a continuous region extending from a(1, 1) to a(1000, 1000). Because the value of the argument k is 1, the reference region 65b is substantially a continuous region without gaps, unlike the reference region 64b. By comparing the definition region 65a with the reference region 65b, it is seen that the two regions overlap in full. Therefore, the loop in the source code 45 is parallelizable and the source code 45 is, therefore, semantically correct.

A definition region 66a is defined based on the loop in the source code 46. Specifically, the definition region 66a is a continuous region extending from a(2, 1) to a(999, 1). A reference region 66b is referenced based on the loop in the source code 46. Specifically, the reference region 66b is a collection of regions spaced at regular intervals like a(1, 2), a(1, 3), . . . , and a(1, 999). By comparing the definition region 66a with the reference region 66b, it is seen that the two regions have no overlap. Therefore, the loop in the source code 46 is parallelizable and the source code 46 is, therefore, semantically correct.

The definition region 64a is statically calculated, and the reference region 64b is calculated from the argument k. Therefore, the parallel computing device 100 is able to calculate, before the execution of the loop, the definition region 64a and the reference region 64b to thereby determine that the loop is not parallelizable. In a similar fashion, the definition region 65a is statically calculated, and the reference region 65b is calculated from the argument k. Therefore, the parallel computing device 100 is able to calculate, before the execution of the loop, the definition region 65a and the reference region 65b to thereby determine that the loop is parallelizable. In addition, the definition region 66a and the reference region 66b are calculated from the arguments k1 and k2. Therefore, the parallel computing device 100 is able to calculate, before the execution of the loop, the definition region 66a and the reference region 66b to thereby determine that the loop is parallelizable. Thus, when the definition region is a continuous region and the reference region is a collection of regularly spaced regions, it is possible to determine before the execution of a loop whether the loop is parallelizable. Note that the reference region 65b is continuous, however, the value of the argument k is not known at the time of compilation. Therefore, object code is generated from the source code 45 with the assumption that the reference region 65b is a collection of regularly spaced regions.

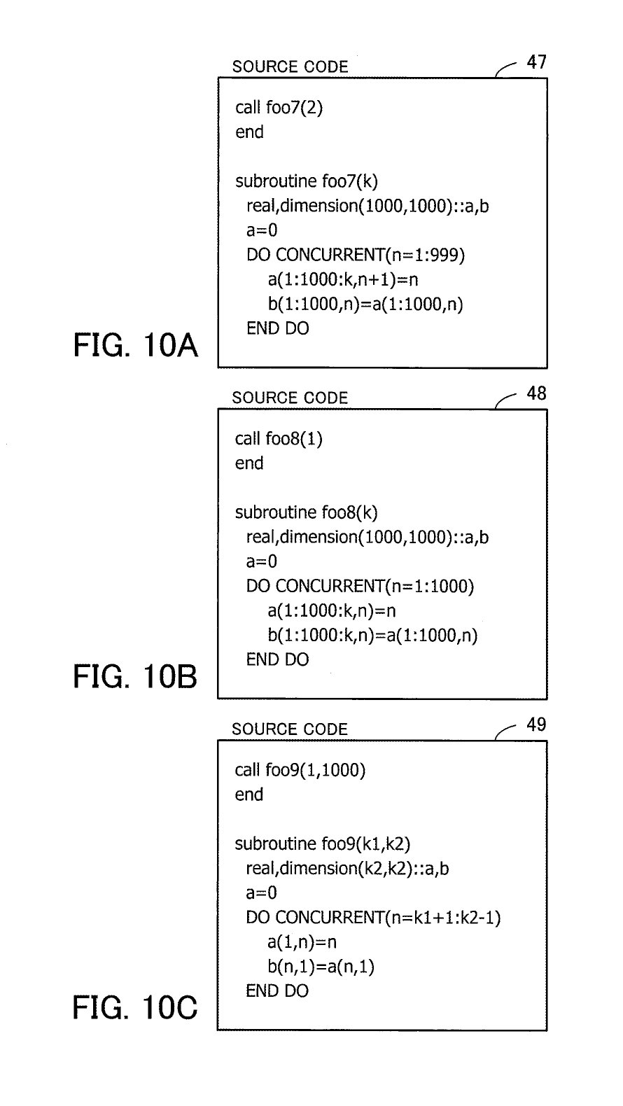

FIGS. 10A to 10C are a third set of diagrams illustrating source code examples. Source code 47 contains subroutine foo7. Subroutine foo7 takes k as an argument. Subroutine foo7 defines a two-dimensional real array a of 1000×1000. Subroutine foo7 executes a loop while increasing the value of the loop variable n by 1 from 1 to 999. The loop includes definition processing for defining elements in a range (1, n+1) to (1000, n+1) of the two-dimensional array a. Note however that the elements to be defined are selected at the rate of one for every k elements. The loop also includes reference processing for referencing elements in the range (1, n) to (1000, n) of the two-dimensional array a. The definition region of the two-dimensional array a depends on the argument k whose value is determined at runtime. The source code 47 contains a call statement to call subroutine foo7 with designation of k=2 as an argument.

Source code 48 contains subroutine foo8. Subroutine foo8 takes k as an argument. Subroutine foo8 executes a loop while increasing the value of the loop variable n by 1 from 1 to 1000. The loop includes definition processing for defining elements in the range (1, n) to (1000, n) of the two-dimensional array a. Note however that the elements to be defined are selected at the rate of one for every k elements. The loop also includes reference processing for referencing elements in the range (1, n) to (1000, n) of the two-dimensional array a. The definition region of the two-dimensional array a depends on the argument k whose value is determined at runtime. The source code 48 contains a call statement to call subroutine foo8 with designation of k=1 as an argument.

Source code 49 contains subroutine foo9. Subroutine foo9 takes k1 and k2 as arguments. Subroutine foo9 executes a loop while increasing the value of the loop variable n by 1 from k1+1 to k2−1. The loop includes definition processing for defining the elements (1, n) of the two-dimensional array a and reference processing for referencing the elements (n, 1) of the two-dimensional array a. The definition and reference regions of the two-dimensional array a depend on the arguments k1 and k2 whose values are determined at runtime. The source code 49 contains a call statement to call subroutine foo9 with designation of k1=1 and k2=1000 as arguments.

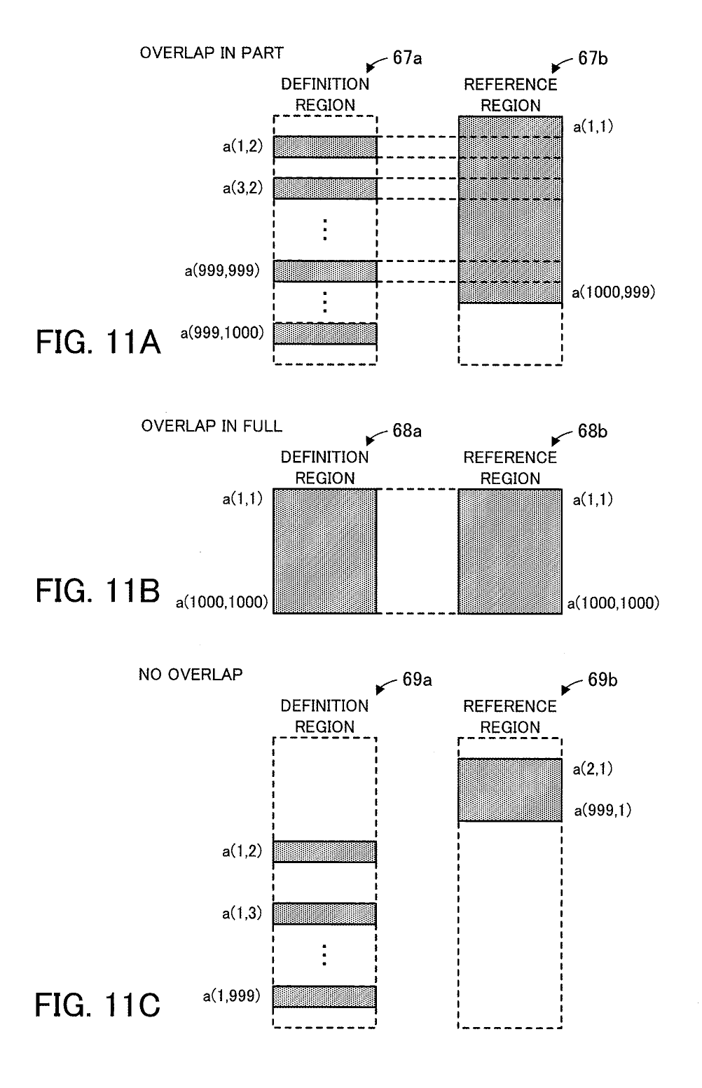

FIGS. 11A to 11C are a third set of diagrams illustrating relationship examples between the definition region and the reference region. A definition region 67a is defined based on the loop in the source code 47. Specifically, the definition region 67a is a collection of regions spaced at regular intervals like a(1, 2), a(3, 2), . . . , a(999, 999), . . . , and a(999, 1000). A reference region 67b is referenced based on the loop in the source code 47. Specifically, the reference region 67b is a continuous region extending from a(1, 1) to a(1000, 999). By comparing the definition region 67a with the reference region 67b, a(1, 2), . . . , and a(999, 999) of the definition region 67a overlap the reference region 67b. On the other hand, a(1, 1000), . . . , and a(999, 1000) of the definition region 67a do not overlap the reference region 67b. That is, the definition region 67a and the reference region 67b overlap in part. Therefore, the loop in the source code 47 is not parallelizable and the source code 47 is, therefore, semantically wrong.

A definition region 68a is defined based on the loop in the source code 48. Specifically, the definition region 68a is a continuous region extending from a(1, 1) to a(1000, 1000). A reference region 68b is referenced based on the loop in the source code 48. Specifically, the reference region 68b is a continuous region extending from a(1, 1) to a(1000, 1000). Because the value of the argument k is 1, the definition region 68b is substantially a continuous region without gaps, unlike the definition region 67a. By comparing the definition region 68a with the reference region 68b, it is seen that the two regions overlap in full. Therefore, the loop in the source code 48 is parallelizable and the source code 48 is, therefore, semantically correct.

A definition region 69a is defined based on the loop in the source code 49. Specifically, the definition region 69a is a collection of regions spaced at regular intervals like a(1, 2), a(1, 3), . . . , and a(1, 999). A reference region 69b is referenced based on the loop in the source code 49. The reference region 69b is a continuous region extending from a(2, 1) to a(999, 1). By comparing the definition region 69a with the reference region 69b, it is seen that the two regions have no overlap. Therefore, the loop in the source code 49 is parallelizable and the source code 49 is, therefore, semantically correct.

The definition region 67a is calculated from the argument k, and the reference region 67b is statically calculated. Therefore, the parallel computing device 100 is able to calculate, before the execution of the loop, the definition region 67a and the reference region 67b to thereby determine that the loop is not parallelizable. In a similar fashion, the definition region 68a is calculated from the argument k, and the reference region 68b is calculated from the argument k. Therefore, the parallel computing device 100 is able to calculate, before the execution of the loop, the definition region 68a and the reference region 68b to thereby determine that the loop is parallelizable. In addition, the definition region 69a and the reference region 69b are calculated from the arguments k1 and k2. Therefore, the parallel computing device 100 is able to calculate, before the execution of the loop, the definition region 69a and the reference region 69b to thereby determine that the loop is parallelizable. Thus, when the definition region is a collection of regularly spaced regions and the reference region is a continuous region, it is possible to determine before the execution of a loop whether the loop is parallelizable. Note that the definition region 68a is continuous, however, the value of the argument k is not known at the time of compilation. Therefore, object code is generated from the source code 48 with the assumption that the definition region 68a is a collection of regularly spaced regions.

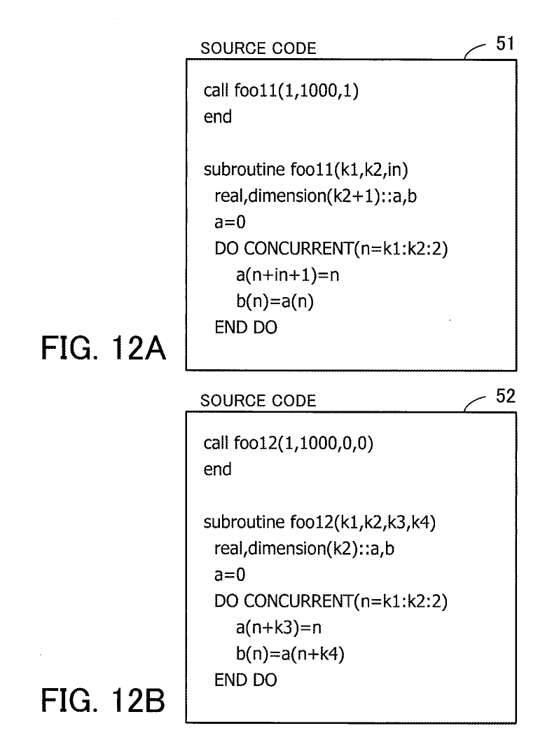

FIGS. 12A and 12B are a fourth set of diagrams illustrating source code examples. Source code 51 contains subroutine foo11. Subroutine foo11 takes k1, k2, and in as arguments. Subroutine foo11 executes a loop while increasing the value of the loop variable n by 2 from k1 to k2. The loop includes definition processing for defining the (n+in+1)^{th} elements in the array a and reference processing for referencing the n^{th} elements in the array a. The definition and reference regions in the array a depend on the arguments k1, k2, and in whose values are determined at runtime. The source code 51 contains a call statement to call subroutine foo11 with designation of k1=1, k2=1000, and in=1 as arguments.

Source code 52 contains subroutine foo12. Subroutine foo12 takes k1, k2, k3, and k4 as arguments. Subroutine foo12 executes a loop while increasing the value of the loop variable n by 2 from k1 to k2. The loop includes definition processing for defining the (n+k3)^{th} elements in the array a and reference processing for referencing the (n+k4)^{th} elements in the array a. The definition and reference regions in the array a depend on the arguments k1, k2, k3, and k4 whose values are determined at runtime. The source code 52 contains a call statement to call subroutine foo12 with designation of k1=1, k2=1000, k3=0, and k4=0 as arguments.

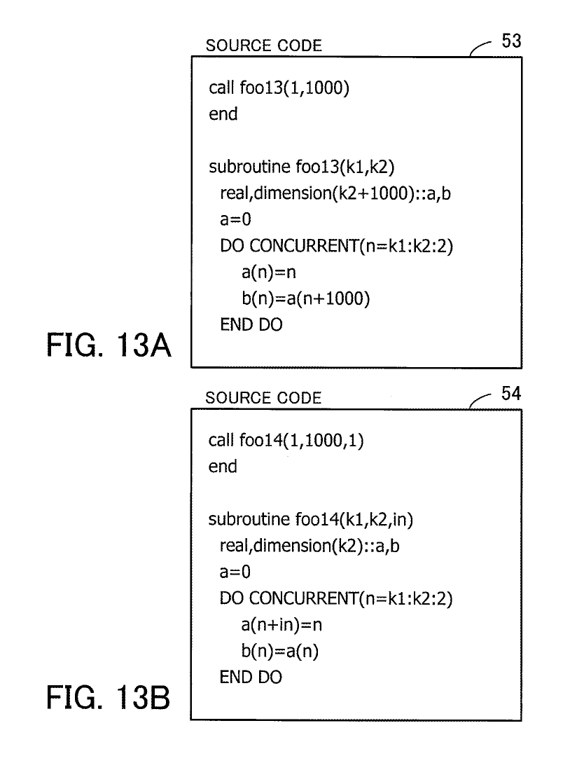

FIGS. 13A and 13B are a fifth set of diagrams illustrating source code examples. Source code 53 contains subroutine foo13. Subroutine foo13 takes k1 and k2 as arguments. Subroutine foo13 executes a loop while increasing the value of the loop variable n by 2 from k1 to k2. The loop includes definition processing for defining the n^{th} elements in the array a and reference processing for referencing the (n+1000)^{th} elements in the array a. The definition and reference regions in the array a depend on the arguments k1 and k2 whose values are determined at runtime. The source code 53 contains a call statement to call subroutine foo13 with designation of k1=1 and k2=1000 as arguments.

Source code 54 contains subroutine foo14. Subroutine foo14 takes k1, k2, and in as arguments. Subroutine foo14 executes a loop while increasing the value of the loop variable n by 2 from k1 to k2. The loop includes definition processing for defining the (n+in)^{th} elements in the array a and reference processing for referencing the n^{th} elements in the array a. The definition and reference regions in the array a depend on the arguments k1, k2, and in whose values are determined at runtime. The source code 54 contains a call statement to call subroutine foo14 with designation of k1=1, k2=1000, and in=1 as arguments.

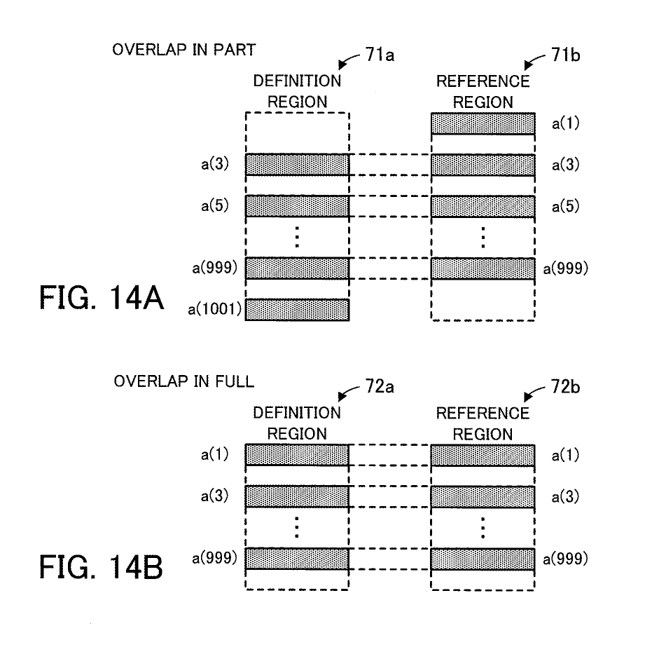

FIGS. 14A and 14B are a fourth set of diagrams illustrating relationship examples between the definition region and the reference region. A definition region 71a is defined based on the loop in the source code 51. Specifically, the definition region 71a is a collection of regions spaced at regular intervals like a(3), a(5) a(999), and a(1001). A reference region 71b is referenced based on the loop in the source code 51. Specifically, the reference region 71b is a collection of regions spaced at regular intervals like a(1), a(3), a(5), . . . , and a(999). By comparing the definition region 71a with the reference region 71b, it is seen that the two regions overlap at a(3), a(5), . . . , and a(999) but do not overlap at a(1) and a(1001). That is, the definition region 71a and the reference region 71b overlap in part. Therefore, the loop in the source code 51 is not parallelizable and the source code 51 is, therefore, semantically wrong.

A definition region 72a is defined based on the loop in the source code 52. Specifically, the definition region 72a is a collection of regions spaced at regular intervals like a(1), a(3), . . . , and a(999). A reference region 72b is referenced based on the loop in the source code 52. Specifically, the reference region 72b is a collection of regions spaced at regular intervals like a(1), a(3), . . . , and a(999). By comparing the definition region 72a with the reference region 72b, it is seen that the two regions overlap in full. That is, the definition region 72a and the reference region 72b overlap in full. Therefore, the loop in the source code 52 is parallelizable and the source code 52 is, therefore, semantically correct.

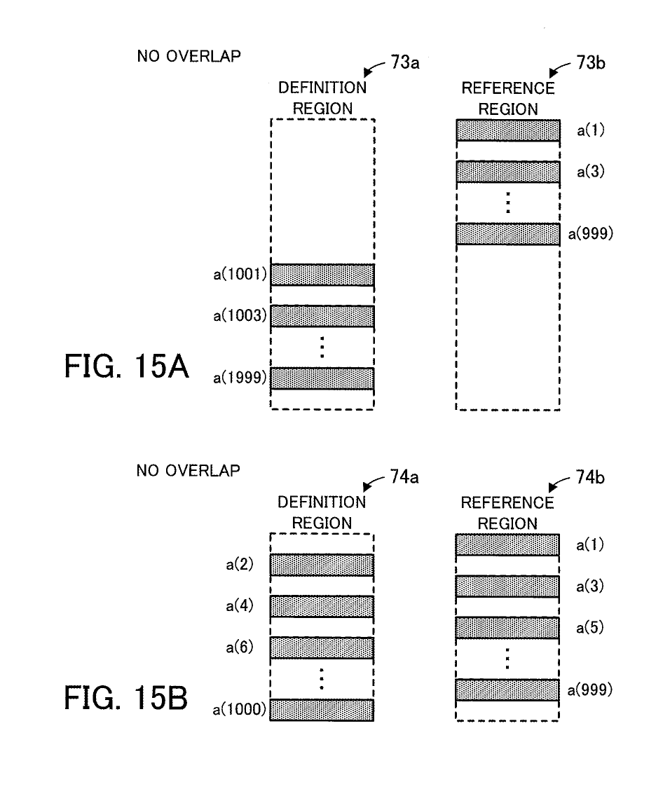

FIGS. 15A and 15B are a fifth set of diagrams illustrating relationship examples between the definition region and the reference region. A definition region 73a is defined based on the loop in the source code 53. Specifically, the definition region 73a is a collection of regions spaced at regular intervals like a(1001), a(1003), and a(1999). A reference region 73b is . . . , referenced based on the loop in the source code 53. Specifically, the reference region 73b is a collection of regions spaced at regular intervals like a(1), a(3) and a(999). By comparing the definition region 73a with the reference region 73b, it is seen that the two regions have no overlap. Therefore, the loop in the source code 53 is parallelizable and the source code 53 is, therefore, semantically correct.

A definition region 74a is defined based on the loop in the source code 54. Specifically, the definition region 74a is a collection of regions spaced at regular intervals like a(2), a(4), a(6), . . . , and a(1000). A reference region 74b is referenced based on the loop in the source code 54. Specifically, the reference region 74b is a collection of regions spaced at regular intervals, corresponding to a(1), a(3), a(5), . . . , and a(999). By comparing the definition region 74a with the reference region 74b, it is seen that the two regions have no overlap since the definition region 74a includes only even-numbered elements while the reference region 74b includes only odd-numbered elements. Therefore, the loop in the source code 54 is parallelizable and the source code 54 is, therefore, semantically correct.

The definition region 71a and the reference region 71b are calculated from the arguments k1, k2, and in. Therefore, the parallel computing device 100 is able to calculate, before the execution of the loop, the definition region 71a and the reference region 71b to thereby determine that the loop is not parallelizable. In a similar fashion, the definition region 72a and the reference region 72b are calculated from the arguments k1, k2, k3, and k4. Therefore, the parallel computing device 100 is able to calculate, before the execution of the loop, the definition region 72a and the reference region 72b to thereby determine that the loop is parallelizable. In addition, the definition region 73a and the reference region 73b are calculated from the arguments k1 and k2. Therefore, the parallel computing device 100 is able to calculate, before the execution of the loop, the definition region 73a and the reference region 73b to thereby determine that the loop is parallelizable. The definition region 74a and the reference region 74b are calculated from the arguments k1, k2, and in. Therefore, the parallel computing device 100 is able to calculate, before the execution of the loop, the definition region 74a and the reference region 74b to thereby determine that the loop is parallelizable. Thus, when each of the definition and reference regions is a collection of regions spaced at regular intervals, it is possible to determine before the execution of a loop whether the loop is parallelizable.

As described later, when detecting array definition processing in a loop, the compiling device 200 is able to determine, based on the description of source code, whether the definition region is a continuous region, a collection of regularly spaced regions, or something other than these (i.e., a collection of irregularly spaced regions). In addition, when detecting array reference processing in a loop, the compiling device 200 is able to determine, based on the description of source code, whether the reference region is a continuous region, a collection of regularly spaced regions, or a collection of irregularly spaced regions.

As described above, it is possible to compare, before the execution of a loop, a continuous definition region or a collection of regularly spaced definition regions with a continuous reference region or a collection of regularly spaced reference regions. On the other hand, if at least one of the definition region and the reference region is a collection of irregularly spaced regions, it is difficult to compare these regions before the execution of a loop. In this case, the loop parallelizability is determined within the loop. Note however that it is often the case that each of the definition region and the reference region is either a continuous region or a collection of regularly spaced regions. Therefore, the parallelization analysis is performed outside a loop in many cases and less likely to be performed within a loop.

Some programming languages use a pointer variable to point to an array. The array pointed to by the pointer variable may be dynamically changed at runtime. For this reason, it is not easy to determine, from source code, an array actually pointed to by each pointer variable. In view of the problem, the compiling device 200 generates object code in such a manner that the comparison between the definition region and the reference region is made with the assumption that a pointer variable appearing in source code may point to any array defined in the source code.

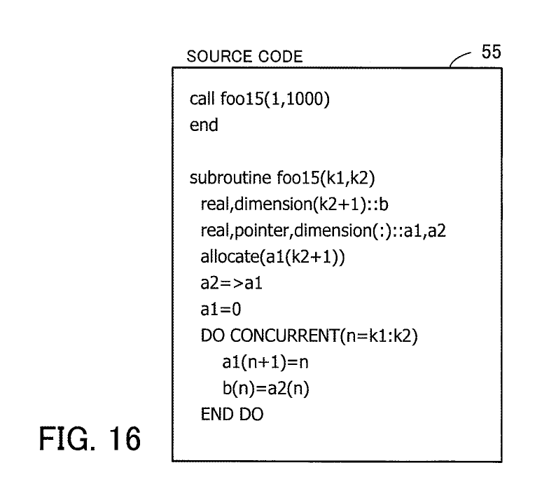

FIG. 16 illustrates a sixth diagram illustrating a source code example. Source code 55 contains subroutine foo15. Subroutine foo15 takes k1 and k2 as arguments. Subroutine foo15 defines a real array b with a length of k2+1 and pointer variables a1 and a2 each pointing to a real array. Subroutine foo15 allocates an array with a length of k2+1 to the pointer variable a1 and also sets the pointer variable a2 to point to the same array as the pointer variable a1 does. Then, subroutine foo15 executes a loop while increasing the value of the loop variable n by 1 from k1 to k2. The loop includes definition processing for defining the (n+1)^{th} elements in the array pointed to by the pointer variable a1 and reference processing for referencing the n^{th} elements in the array pointed to by the pointer variable a2.

Note here that, because the variable name associated with the definition is “a1” and the variable name associated with the reference is “a2”, it may appear that the array to be defined and the array to be referenced are different. However, the pointer variable a2 actually points to the same array as the pointer variable a1, and the array to be defined and the array to be referenced are therefore the same. In this case, it is preferable to determine the loop parallelizability by comparing the definition region corresponding to “a1” with the reference region corresponding to “a2”.

Note however that it is difficult for the compiling device 200 to statically determine at the time of compilation that the arrays pointed to by the individual pointer variables a1 and a2 are the same. For this reason, the compiling device 200 assumes that the pointer variables a1 and a2 point to any array appearing in the source code 55. That is, the compiling device 200 assumes that the array pointed to by the pointer variable a2 is the same as the array b, and is also the same as the array pointed to by the pointer variable a1. In this case, the compiling device 200 generates object code in such a manner that comparisons are made between the definition region in the array b and the reference region in the array pointed to by the pointer variable a2 and also between the definition region in the array pointed to by the pointer variable a1 and the reference region in the array pointed to by the pointer variable a2. Note that the definition region and the reference region are identified by runtime memory addresses. Therefore, as for a comparison between the definition region and the reference region in different arrays, it is determined at runtime that no overlap exists between the two regions.

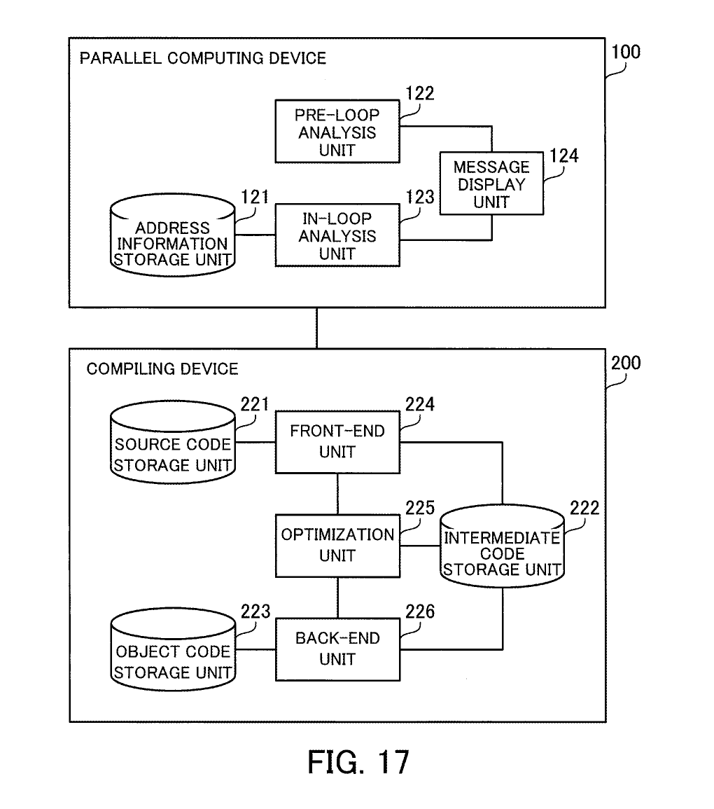

Next described are functions of the parallel computing device 100 and the compiling device 200. FIG. 17 is a block diagram illustrating an example of functions of the parallel computing device and the compiling device. The parallel computing device 100 includes an address information storage unit 121, a pre-loop analysis unit 122, an in-loop analysis unit 123, and a message display unit 124. The address information storage unit 121 is implemented as a storage area secured in the RAM 102 or the HDD 103. Each of the pre-loop analysis unit 122 and the in-loop analysis unit 123 is implemented using a program module which is a library called by object code. The library is executed by, for example, one of the CPU cores 101a to 101d. The CPU core for executing the library may be a CPU core for executing one of a plurality of threads running in parallel. The message display unit 124 may be implemented as a program module.

The address information storage unit 121 stores therein address information. The address information is generated and stored in the address information storage unit 121 by the in-loop analysis unit 123, and read by the in-loop analysis unit 123. The address information includes addresses of defined array elements (individual definition addresses) and addresses of referenced array elements (individual reference addresses).

The pre-loop analysis unit 122 is called from object code generated by the compiling device 200 immediately before the execution of a loop. The pre-loop analysis unit 122 acquires parameters for each continuous region definition, continuous region reference, regularly spaced region definition, and regularly spaced region reference. The parameters may be also called “arguments” or “variables”. These parameters may include ones whose values remain undetermined at the time of compilation but determined at runtime. Based on the acquired parameters, the pre-loop analysis unit 122 calculates each continuous definition region, continuous reference region, collection of regularly spaced definition regions, and collection of regularly spaced reference regions. The pre-loop analysis unit 122 compares each of the calculated continuous definition regions or collections of regularly spaced definition regions with each of the calculated continuous reference regions or collections of regularly spaced reference regions to thereby determine whether the loop is parallelizable. As described above, the loop is determined to be not parallelizable when the definition and reference regions overlap in part, and the loop is determined to be parallelizable when the definition and reference regions overlap in full or have no overlap.

The in-loop analysis unit 123 is called from the object code generated by the compiling device 200 during the execution of a loop. Therefore, in order to perform in-loop analysis, the in-loop analysis unit 123 is called once or more per iteration of the loop. Note however that because each of the definition and reference regions is often either a single continuous region or a collection of regularly spaced regions, as mentioned above, the in-loop analysis unit 123 being called is expected to be less likely. The in-loop analysis unit 123 acquires information used in the in-loop analysis, such as individual definition addresses and individual reference addresses. Information on each continuous definition region, continuous reference region, collection of regularly spaced definition regions, and collection of regularly spaced reference regions may be acquired from the pre-loop analysis unit 122.

The in-loop analysis unit 123 stores individual definition addresses and individual reference addresses in the address information storage unit 121. In addition, the in-loop analysis unit 123 compares an individual definition address against each continuous reference region and collection of regularly spaced reference regions. If the individual definition address is included in the continuous reference region or the collection of regularly spaced reference regions, a loop in question is in principle determined not to be parallelizable. The in-loop analysis unit 123 also compares the individual definition address with individual reference addresses accumulated in the address information storage unit 121. If there is a match in the address information storage unit 121, the loop is in principle determined not to be parallelizable. Further, the in-loop analysis unit 123 compares an individual reference address against each continuous definition region and collection of regularly spaced definition regions. If the individual reference address is included in the continuous definition region or the collection of regularly spaced definition regions, the loop is in principle determined not to be parallelizable. In addition, the in-loop analysis unit 123 compares the individual reference address with individual definition addresses accumulated in the address information storage unit 121. If there is a match in the address information storage unit 121, the loop is in principle determined not to be parallelizable.

When the pre-loop analysis unit 122 or the in-loop analysis unit 123 has determined the condition of the loop being not parallelizable, the message display unit 124 generates a message to warn about the loop being not parallelizable. The message display unit 124 displays the generated message on the display 111. Note however that the message display unit 124 may add the generated message to a log stored in the RAM 102 or the HDD 103. The message display unit 124 may transmit the generated message to a different device via the network 30. The message display unit 124 may reproduce the generated message as an audio message.

The compiling device 200 includes a source code storage unit 221, an intermediate code storage unit 222, an object code storage unit 223, a front-end unit 224, an optimization unit 225, and a back-end unit 226. Each of the source code storage unit 221, the intermediate code storage unit 222, and the object code storage unit 223 is implemented as a storage area secured in the RAM 202 or the HDD 203. The front-end unit 224, the optimization unit 225, and the back-end unit 226 are implemented using program modules.

The source code storage unit 221 stores therein source code (such as the source code 41 to 49 and 51 to 55 described above) created by the user. The source code is written in a programming language, such as FORTRAN. The source code may include a loop. As for such a loop, parallelization of the loop may have been instructed by the user. A parallel directive may be defined by the specification of the programming language, or may be written in an extension language, such as OpenMP, and added to the source code. The intermediate code storage unit 222 stores therein intermediate code converted from the source code. The intermediate code is written in an intermediate language used inside the compiling device 200. The object code storage unit 223 stores therein machine-readable object code corresponding to the source code. The object code is executed by the parallel computing device 100.

The front-end unit 224 performs a front-end process for compilation. That is, the front-end unit 224 reads the source code from the source code storage unit 221 and analyzes the read source code. The analysis of the source code includes lexical analysis, parsing, and semantic analysis. The front-end unit 224 generates intermediate code corresponding to the source code and stores the generated intermediate code in the intermediate code storage unit 222. In the case where a predetermined compilation option (for example, debug option) is attached to a compile command input by the user, the front-end unit 224 inserts parallelization analysis to determine loop parallelizability. The insertion of the parallelization analysis may be made either to the source code before it is translated into the intermediate code or to the intermediate code after the translation.

The front-end unit 224 extracts each array definition instruction from a loop and estimates, based on description of its index and loop variable, whether the definition region will be a continuous region or a collection of regularly or irregularly spaced regions. In addition, the front-end unit 224 extracts each array reference instruction from the loop and estimates, based on its index and loop variable, whether the reference region will be a continuous region or a collection of regularly or irregularly spaces regions. In the case where a continuous definition region, a continuous reference region, a collection of regularly spaced definition regions, and a collection of regularly spaced reference regions are present, the front-end unit 224 inserts, immediately before the loop, an instruction to calculate parameter values and call a library. In the case where a collection of irregularly spaced definition regions and a collection of irregularly spaced reference regions are present, the front-end unit 224 inserts an instruction to call a library inside the loop.

The optimization unit 225 reads the intermediate code from the intermediate code storage unit 222 and performs various optimization tasks on the intermediate code so as to generate object code with high execution efficiency. The optimization tasks include parallelization using a plurality of CPU cores. The optimization unit 225 detects parallelizable processing from the intermediate code and rewrites the intermediate code in such a manner that a plurality of threads are run in parallel. When the parallelization analysis is not performed inside a loop, the loop may be parallelizable. That is, n iterations (i.e., repeating a process n times) may be distributed and the i^{th} and j^{th} iterations of the n iterations may be run by different CPU cores. On the other hand, when the parallelization analysis is performed inside a loop, the loop is not parallelized because a dependency relationship arises between the iterations.

The back-end unit 226 performs a back-end process for compilation. That is, the back-end unit 226 reads the optimized intermediate code from the intermediate code storage unit 222 and converts the read intermediate code into object code. The back-end unit 226 may generate assembly code written in an assembly language from the intermediate code and convert the assembly code into object code. The back-end unit 226 stores the generated object code in the object code storage unit 223.

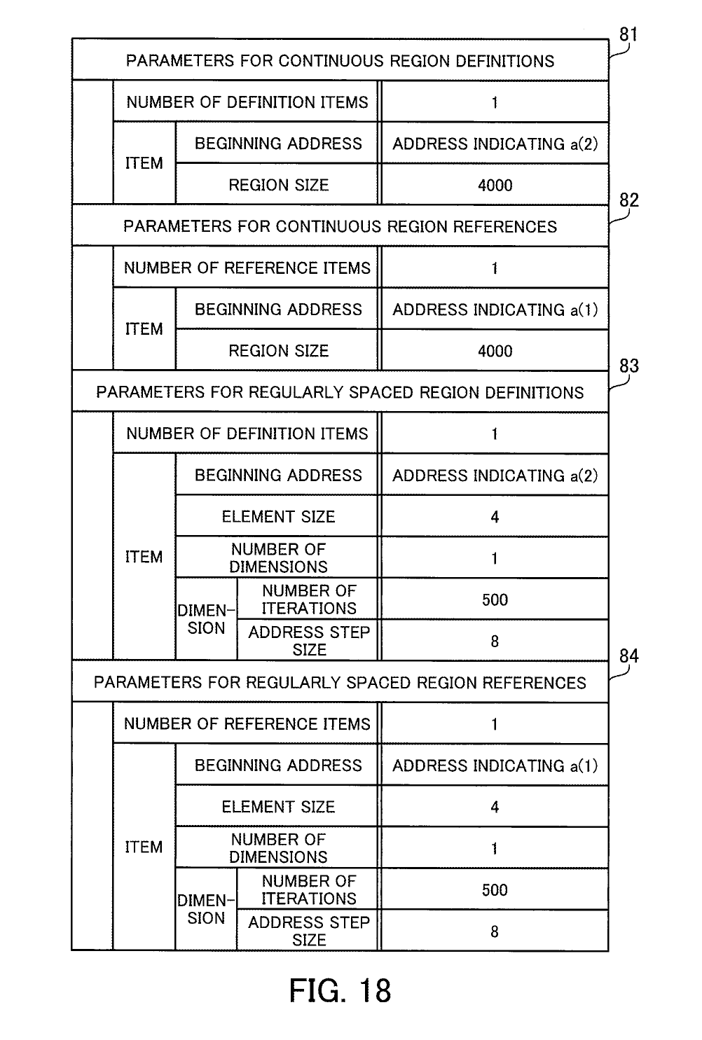

FIG. 18 illustrates an example of parameters for a library call. The object code generated by the compiling device 200 calculates, with respect to each array, values of parameters 81 to 84 illustrated in FIG. 18 immediately before the execution of a loop and calls a library (the pre-loop analysis unit 122). Such a library call is made, for example, for each array. That is, information about definitions and references to the same array is put together.

Parameters 81 are associated with array access where each definition region is continuous (continuous region definition). The parameters 81 include the number of definition items. The number of definition items indicates the number of continuous region definitions within the loop. The number of definition items is calculated at the time of compilation. The parameters 81 include a beginning address and a region size for each definition item. The beginning address is a memory address indicating a first element amongst array elements accessed by the continuous region definition. The region size indicates the size of a definition region (the number of bytes) accessed by the continuous region definition. The beginning address and region size are calculated at runtime.

For example, in the case of the source code 41 of FIG. 6A, assignment of values to “a(n+in)” corresponds to a continuous region definition. In this case, the number of definition items is 1; the beginning address is a memory address indicating a(2); and the region size is calculated as: 4 bytes×1000=4000 bytes. Assume here that each element in the real array occupies 4 bytes. How to determine whether the array definition is a continuous region definition is described later.

Parameters 82 are associated with array access where each reference region is continuous (continuous region reference). The parameters 82 include the number of reference items. The number of reference items indicates the number of continuous region references within the loop. The number of reference items is calculated at the time of compilation. The parameters 82 include a beginning address and a region size for each reference item. The beginning address is a memory address indicating a first element amongst array elements accessed by the continuous region reference. The region size indicates the size of a reference region (the number of bytes) accessed by the continuous region reference. The beginning address and region size are calculated at runtime.

For example, in the case of the source code 41 of FIG. 6A, acquisition of values of “a(n)” corresponds to a continuous region reference. In this case, the number of reference items is 1; the beginning address is a memory address indicating a(1); and the region size is calculated as: 4 bytes×1000=4000 bytes. How to determine whether the array reference is a continuous region reference is described later.

Parameters 83 are associated with array access where each definition region is a collection of regularly spaced regions (regularly spaced region definition). The parameters 83 include the number of definition items. The number of definition items indicates the number of regularly spaced region definitions within the loop. The number of definition items is calculated at the time of compilation. The parameters 83 include, for each definition item, a beginning address, an element size, and the number of dimensions. The beginning address is a memory address indicating a first element amongst array elements accessed by the regularly spaced region definition. The beginning address is calculated at runtime. The element size is the size of each array element (the number of bytes). The number of dimensions is the number of dimensions of an index. The element size and the number of dimensions are calculated at the time of compilation.

The parameters 83 include the number of iterations and the address step size for each dimension of the index. The number of iterations indicates the number of times the value of the index in the dimension changes when the loop is executed. The address step size is an increment in the value of the memory address when the value of the index in the dimension is changed by 1. The number of iterations and the address step size are calculated at runtime.

For example, in the case of the source code 54 of FIG. 13B, assignment of values to “a(n+in)” corresponds to a regularly spaced region definition. In this case, the number of definition items is 1; the beginning address is a memory address indicating a(2); the element size is 4 bytes; and the number of dimensions is 1. In addition, the number of iterations is calculated as: (k2−k1+1)/2=500 iterations; and the address step size is calculated as: 4 bytes×2=8 bytes. How to determine whether the array definition is a regularly spaced region definition is described later.

Parameters 84 are associated with array access where each reference region is a collection of regularly spaced regions (regularly spaced region reference). The parameters 84 include the number of reference items. The number of reference items indicates the number of regularly spaced region references within the loop. The number of reference items is calculated at the time of compilation. The parameters 84 include, for each reference item, a beginning address, an element size, and the number of dimensions. The beginning address is a memory address indicating a first element amongst array elements accessed by the regularly spaced region reference. The beginning address is calculated at runtime. The element size is the size of each array element (the number of bytes). The number of dimensions is the number of dimensions of an index. The element size and the number of dimensions are calculated at the time of compilation.

The parameters 84 include the number of iterations and the address step size for each dimension of the index. The number of iterations indicates the number of times the value of the index in the dimension changes when the loop is executed. The address step size is an increment in the value of the memory address when the value of the index in the dimension is changed by 1. The number of iterations and the address step size are calculated at runtime.

For example, in the case of the source code 54 of FIG. 13B, acquisition of values of “a(n)” corresponds to a regularly spaced region reference. In this case, the number of reference items is 1; the beginning address is a memory address indicating a(1); the element size is 4 bytes; and the number of dimensions is 1. In addition, the number of iterations is calculated as: (k2−k1+1)/2=500 iterations; and the address step size is calculated as: 4 bytes×2=8 bytes. How to determine whether the array reference is a regularly spaced region reference is described later.

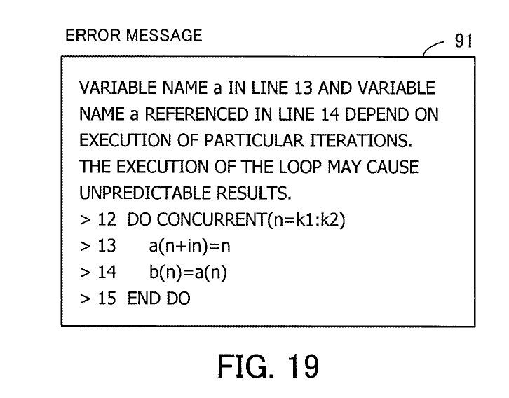

FIG. 19 illustrates a display example of an error message. An error message 91 is generated by the message display unit 124 when a loop is determined to be not parallelizable. The error message 91 is displayed, for example, on a command input window where the user has input a program start command. Assume here that, within the source code, the definition region corresponding to an array definition in line 13 and the reference region corresponding to an array reference in line 14 overlap in part. In this case, for example, the following message is displayed: “Variable name a in line 13 and variable name a referenced in line 14 depend on execution of particular iterations. The execution of the loop may cause unpredictable results.” The message may be added to an error log stored in, for example, the RAM 102 or the HDD 103.

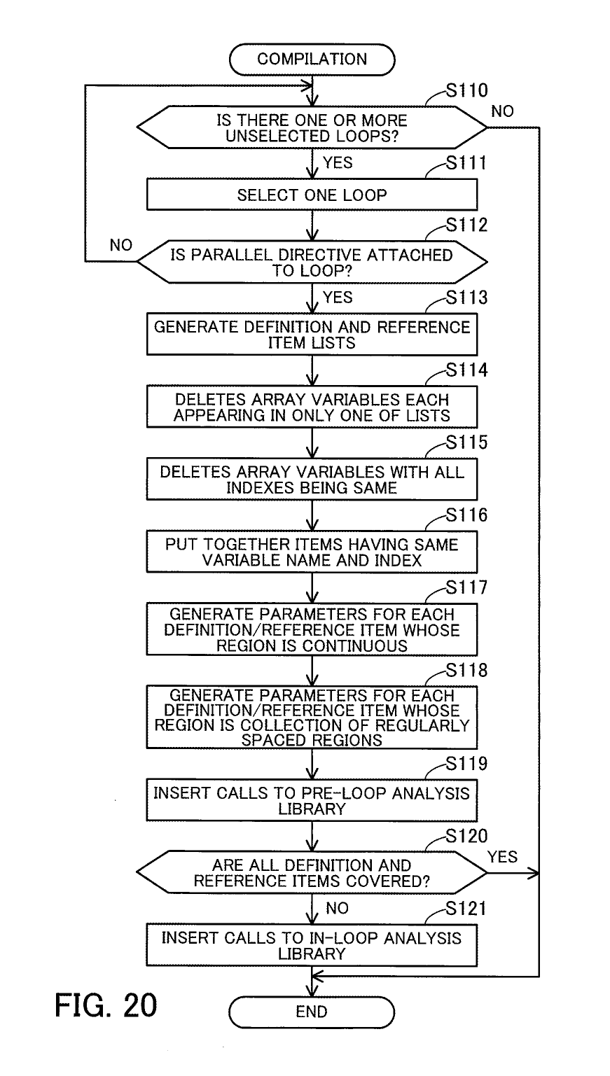

Next described are procedures of the compilation, the pre-loop analysis, and the in-loop analysis. FIG. 20 is a flowchart illustrating a procedure example of the compilation. A process associated with adding analysis functions is mainly described here.

(S110) The front-end unit 224 determines whether there is one or more unselected loops. If there is one or more unselected loops, the process moves to step S111. If not, the process of the front-end unit 224 ends.

(S111) The front-end unit 224 selects one loop.

(S112) The front-end unit 224 determines whether the loop selected in step S111 has a parallel directive attached thereto. A statement that instructs parallelization of a loop may be defined by a specification of its programming language, or may be specified by an extension language different from the programming language. If a parallel directive is attached to the selected loop, the process moves to step S113. If not, the process moves to step S110.

(S113) The front-end unit 224 extracts definition items each indicating an array definition from the loop selected in step S111 and generates a definition item list including the definition items. Each definition item is, for example, an item on the left-hand side of an assignment statement (i.e., the left side of an equals sign) and includes a variable name indicating an array and an index. In addition, the front-end unit 224 extracts reference items each indicating an array reference from the loop selected in step S111 and generates a reference item list including the reference items. Each reference item is, for example, an item on the right-hand side of an assignment statement (the right side of an equals sign) and includes a variable name indicating an array and an index. The definition items and reference items include ones with a pointer variable indicating an array.

(S114) The front-end unit 224 compares the definition item list with the reference item list, both of which are generated in step S113, and then detects one or more variable names appearing on only one of the lists. Subsequently, the front-end unit 224 deletes definition items including the detected variable names from the definition item list, and deletes reference items including the detected variable names from the reference item list. This is because, as for arrays only defined and not referenced and arrays only referenced and not defined, no dependency relationship exists between iterations of the loop. Note however that a pointer variable may point to any array and, therefore, definition items and reference items including variable names of pointer variables are not deleted from the corresponding item lists.

(S115) The front-end unit 224 sorts out definition items included in the definition item list and reference items included in the reference item list according to variable names. If all indexes are the same between a definition item and a reference item having the same variable name, the front-end unit 224 deletes the definition item and the reference item from the definition item list and the reference item list, respectively. This is because, if all the indexes are the same, an element defined in the i^{th} iteration will never be the same as one referenced in the j^{th} iteration (i and j are different positive integers). Note however that definition items and reference items including variable names of pointer variables are not deleted from the corresponding item lists.

(S116) The front-end unit 224 puts together definition items having the same variable name and index in the definition item list. In addition, the front-end unit 224 puts together reference items having the same variable name and index in the reference item list.

(S117) The front-end unit 224 extracts, from the definition item list, definition items each of whose definition region is continuous. Each definition item whose definition region is continuous satisfies condition #1 below. In addition, the front-end unit 224 extracts, from the reference item list, reference items each of whose reference region is continuous. Each reference item whose reference region is continuous satisfies condition #1 below.

Condition #1 is to meet all of the following [1a], [1b], and [1c]. [1a] only one loop variable is included in the index; [1b] the index is expressed either by the loop variable only or as an addition or subtraction of the loop variable and a constant or a different variable; and [1c] the step size of the loop variable is omitted or set to 1. For example, while “a(n)” and “a(n+in)” meet the above [1b], “a(2n)” does not meet [1b]. “DO CONCURRENT (n=1:1000:1)” meets the above [1c] but “DO CONCURRENT (n=1:1000:2)” does not meet [1c].

The front-end unit 224 generates the parameters 81 of FIG. 18 for each of the extracted definition items, and generates the parameters 82 of FIG. 18 for each of the extracted reference items. Note however that the parameters 81 and 82 may include parameters whose values are determined or not determined at the time of compilation. For each parameter whose value is not determined at the time of compilation, a method for calculating the value of the parameter is identified based on variable values determined at runtime. For example, in the case of the source code 41 of FIG. 6A, the region size is calculated as: (k2−k1+1)×4.

(S118) The front-end unit 224 extracts, from the definition item list, definition items each of whose definition region is a collection of regularly spaced regions. Each definition item whose definition region is a collection of regularly spaced regions satisfies either condition #2 or #3 below. In addition, the front-end unit 224 extracts, from the reference item list, reference items each of whose reference region is a collection of regularly spaced regions. Each reference item whose reference region is a collection of regularly spaced regions satisfies either condition #2 or #3 below.

Condition #2 is to meet both of the following [2a] and [2b]. [2a] the number of dimensions is two or more, and two or more loop variables are individually included in different dimensions; and [2b] as for each dimension including a loop variable, the index is expressed either by the loop variable only or as an addition or subtraction of the loop variable and a constant or a different variable. For example, “DO CONCURRENT (n1=1:1000, n2=1:1000) . . . a(n1+k1, n2)” meets the above [2a] and [2b].

Condition #3 is to meet all of the following [3a], [3b], and [3c]. [3a] the index includes only one loop variable; [3b] the index is expressed either by the loop variable only or as an addition or subtraction of the loop variable and a constant or a different variable; and [3c] the step size of the loop variable is more than 1, or is a variable and possibly more than 1. For example, “DO CONCURRENT (n=1:1000;k) . . . a(n)” meets the above [3a] to [3c].

The front-end unit 224 generates the parameters 83 of FIG. 18 for each of the extracted definition items, and generates the parameters 84 of FIG. 18 for each of the extracted reference items. Note however that the parameters 83 and 84 may include parameters whose values are determined or not determined at the time of compilation. For each parameter whose value is not determined at the time of compilation, a method for calculating the value of the parameter is identified based on variable values determined at runtime. For example, in the case of the source code 54 of FIG. 13B, the number of iterations is calculated as: (k2−k1+1)/2.

(S119) As for the parameters 81 and 82 generated in step S117 and the parameters 83 and 84 generated in step S118, the front-end unit 224 puts together parameters associated with the same array (i.e., the same variable name). Note however that a pointer variable may point to any array and, therefore, the front-end unit 224 assumes that an array pointed to by the pointer variable is the same as all the remaining arrays. The front-end unit 224 inserts a library call statement immediately before the loop for each array (each variable name). Each library call defines the parameters 81 to 84 corresponding to the array as arguments.

(S120) The front-end unit 224 determines whether the library calls generated in step S119 cover all the definition and reference items. That is, the front-end unit 224 determines whether each of all the definition items included in the definition item list and all the reference items included in the reference item list corresponds to one of the above conditions #1 to #3. If each of all the definition and reference items corresponds to one of conditions #1 to #3, the front-end unit 224 ends the process. On the other hand, if there is one or more definition or reference items not corresponding to any of conditions #1 to #3, the front-end unit 224 moves to step S121.

(S121) The front-end unit 224 inserts, immediately before the loop, an instruction to initialize a counter C to 1. In addition, as for each definition item not corresponding to any of conditions #1 to #3, the front-end unit 224 inserts, within the loop, a library call statement where the definition item appears. The library call passes addresses of elements to be defined as arguments. In addition, as for each reference item not corresponding to any of conditions #1 to #3, the front-end unit 224 inserts, within the loop, a library call statement where the reference item appears. The library call passes addresses of elements to be referenced as arguments. The front-end unit 224 also inserts an instruction to add 1 to the counter C at the end of the loop.

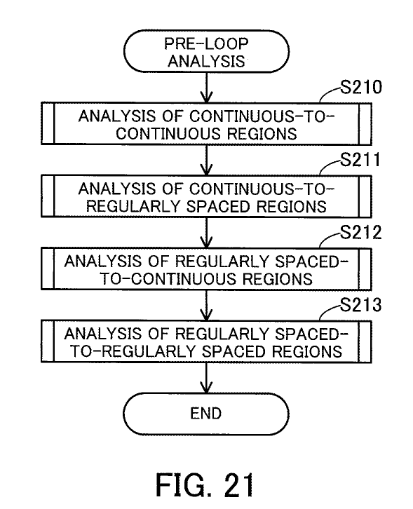

FIG. 21 is a flowchart illustrating a procedure example of the pre-loop analysis.

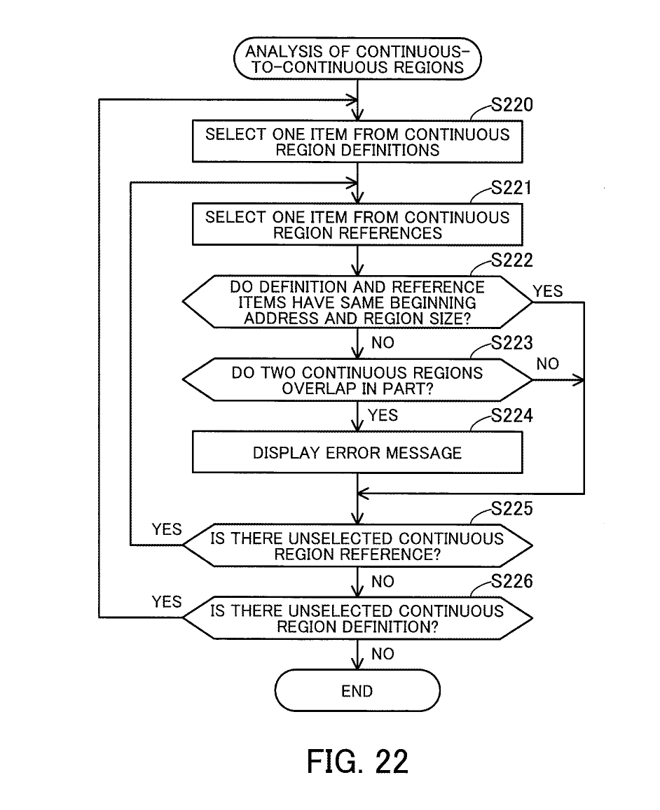

(S210) The pre-loop analysis unit 122 compares continuous definition regions indicated by the parameters with continuous reference regions indicated by the parameters 82 to analyze dependency relationships between iterations. This “analysis of continuous-to-continuous regions” is explained below with reference to FIG. 22.

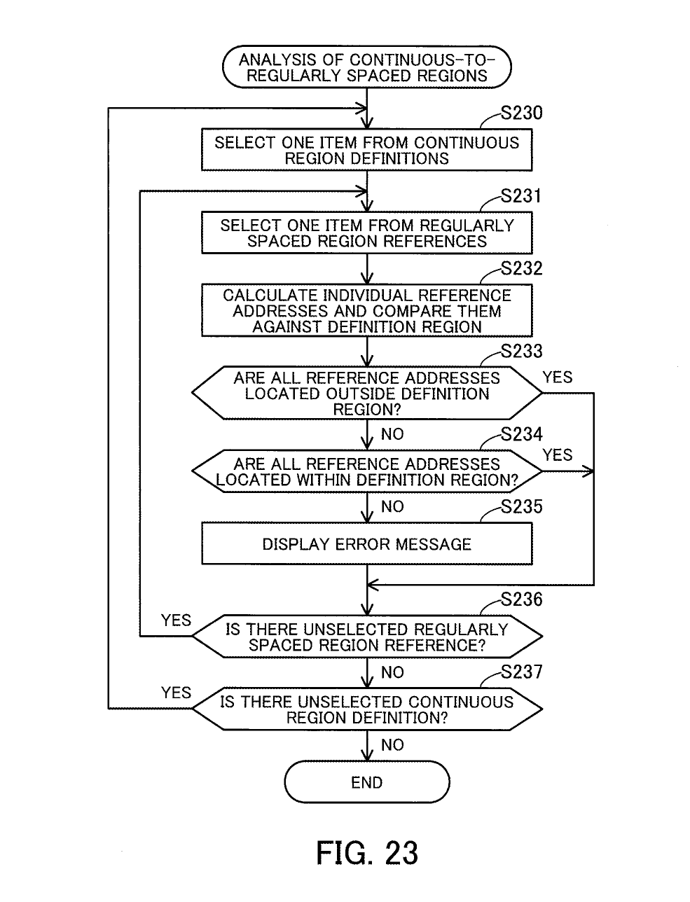

(S211) The pre-loop analysis unit 122 compares the continuous definition regions indicated by the parameters 81 with regularly spaced reference regions indicated by the parameters 84 to analyze dependency relationships between iterations. This “analysis of continuous-to-regularly spaced regions” is explained below with reference to FIG. 23.

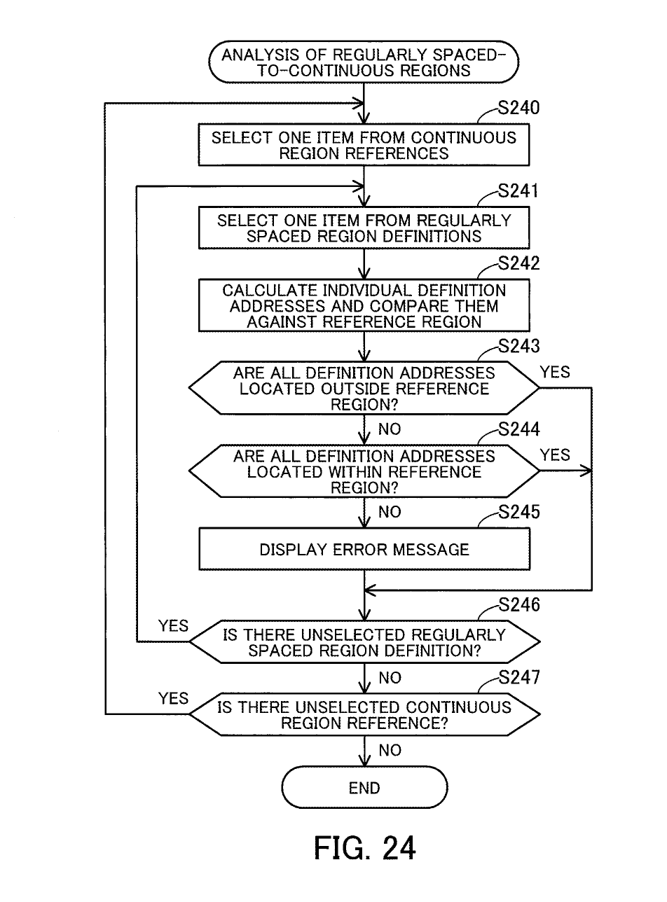

(S212) The pre-loop analysis unit 122 compares regularly spaced definition regions indicated by the parameters 83 with the continuous reference regions indicated by the parameters 82 to analyze dependency relationships between iterations. This “analysis of regularly spaced-to-continuous regions” is explained below with reference to FIG. 24.

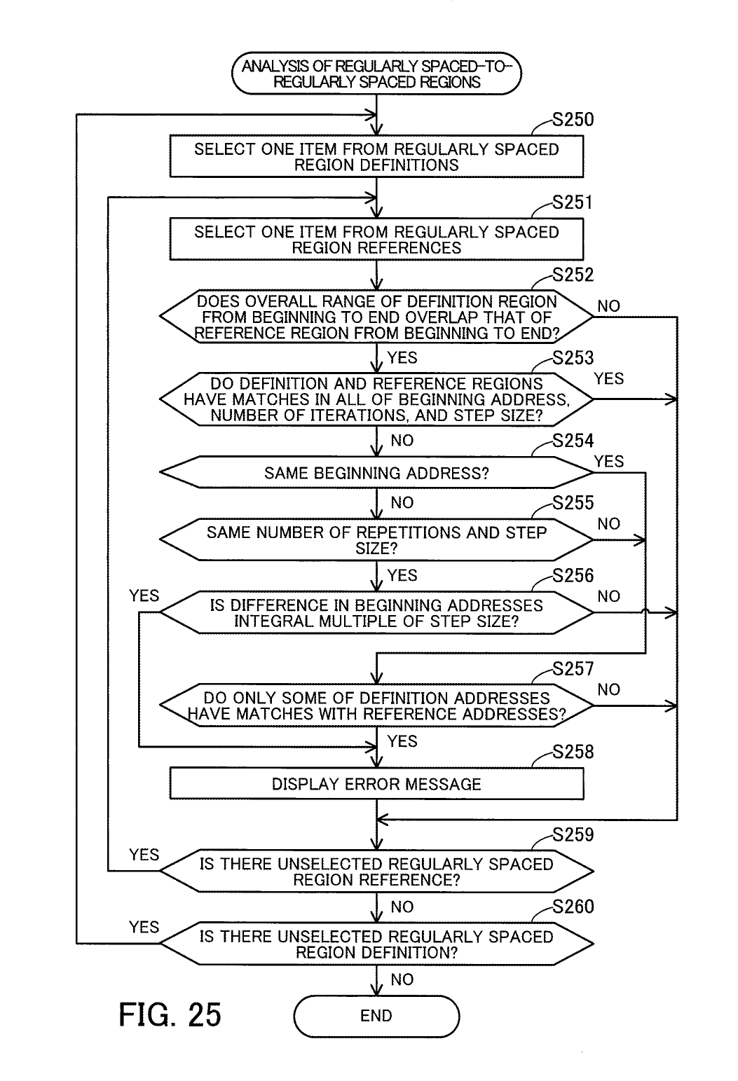

(S213) The pre-loop analysis unit 122 compares the regularly spaced definition regions indicated by the parameters 83 with the regularly spaced reference regions indicated by the parameters 84 to analyze dependency relationships between iterations. This “analysis of regularly spaced-to-regularly spaced regions” is explained below with reference to FIG. 25.

FIG. 22 is a flowchart illustrating a procedure example of the analysis of continuous-to-continuous regions.

(S220) The pre-loop analysis unit 122 selects one definition item from the parameters 81 (parameters associated with continuous region definitions).

(S221) The pre-loop analysis unit 122 selects one reference item from the parameters 82 (parameters associated with continuous region references).

(S222) The pre-loop analysis unit 122 determines whether the beginning address of the definition item is the same as that of the reference item, as well as whether the region size of the definition item is the same as that of the reference item. If the definition and reference items have the same beginning address and region size, the definition region and the reference region overlap in full. In this case, the process moves to step S225. If the definition and reference items differ in at least one of the beginning address and the region size, the process moves to step S223.

(S223) The pre-loop analysis unit 122 determines whether the definition region of the definition item and the reference region of the reference item overlap in part. For example, the pre-loop analysis unit 122 adds the region size of the definition item to the beginning address thereof to calculate the end address of the definition item. If the beginning address of the reference item is located between the beginning and end addresses of the definition item, the definition region and the reference region overlap in part. In addition, the pre-loop analysis unit 122 adds the region size of the reference item to the beginning address thereof to calculate the end address of the reference item. If the beginning address of the definition address is located between the beginning and end addresses of the reference item, the definition region and the reference region overlap in part. If the definition region and the reference region overlap in part, the process moves to step S224. If not, the process moves to step S225.

(S224) The message display unit 124 generates the error message 91. The message display unit 124 displays the error message 91 on the display 111.

(S225) The pre-loop analysis unit 122 determines whether there is one or more unselected reference items in the parameters 82. If there is an unselected reference item, the process moves to step S221. If all the reference items in the parameters 82 have been selected, the process moves to step S226.

(S226) The pre-loop analysis unit 122 determines whether there is one or more unselected definition items in the parameters 81. If there is an unselected definition item, the process moves to step S220. If all the definition items in the parameters 81 have been selected, the analysis of continuous-to-continuous regions ends.

FIG. 23 is a flowchart illustrating a procedure example of the analysis of continuous-to-regularly spaced regions.

(S230) The pre-loop analysis unit 122 selects one definition item from the parameters 81 (parameters associated with continuous region definitions).

(S231) The pre-loop analysis unit 122 selects one reference item from the parameters 84 (parameters associated with regularly spaced region references).

(S232) The pre-loop analysis unit 122 calculates addresses (reference addresses) of individual regions to be accessed regularly based on the reference item and compares them against the definition region indicated by the definition item. For example, the pre-loop analysis unit 122 adds the region size of the definition item to the beginning address thereof to calculate the end address of the definition item. In addition, the pre-loop analysis unit 122 repeatedly adds the address step size to the beginning address of the reference item to thereby calculate all the reference addresses. The pre-loop analysis unit 122 determines whether each of all the reference addresses is included in the definition region identified by the beginning and end addresses of the definition item.

(S233) The pre-loop analysis unit 122 determines whether all the reference addresses are located outside the definition region. If all the reference addresses are located outside the definition region, the definition region and the reference region have no overlap. In this case, the process moves to step S236. On the other hand, if at least one of the reference addresses is located within the definition region, the process moves to step S234.

(S234) The pre-loop analysis unit 122 determines whether all the reference addresses are located within the definition region. If all the reference addresses are located within the definition region, the definition region and the reference region overlap in full. In this case, the process moves to step S236. On the other hand, if one or more of the reference addresses are located within the definition region and the remaining reference addresses are located outside the definition region, that is, if the definition region and the reference region overlap in part, the process moves to step S235.

(S235) The message display unit 124 generates the error message 91. The message display unit 124 displays the error message 91 on the display 111.

(S236) The pre-loop analysis unit 122 determines whether there is one or more unselected reference items in the parameters 84. If there is an unselected reference item, the process moves to step S231. If all the reference items in the parameters 84 have been selected, the process moves to step S237.

(S237) The pre-loop analysis unit 122 determines whether there is one or more unselected definition items in the parameters 81. If there is an unselected definition item, the process moves to step S230. If all the definition items in the parameters 81 have been selected, the analysis of continuous-to-regularly spaced regions ends.

FIG. 24 is a flowchart illustrating a procedure example of the analysis of regularly spaced-to-continuous regions.

(S240) The pre-loop analysis unit 122 selects one reference item from the parameters 82 (parameters associated with continuous region references).

(S241) The pre-loop analysis unit 122 selects one definition item from the parameters 83 (parameters associated with regularly spaced region definitions).

(S242) The pre-loop analysis unit 122 calculates addresses (definition addresses) of individual regions accessed regularly based on the definition item and compares them against the reference region indicated by the reference item. For example, the pre-loop analysis unit 122 adds the region size of the reference item to the beginning address thereof to calculate the end address of the reference item. In addition, the pre-loop analysis unit 122 repeatedly adds the address step size to the beginning address of the definition item to thereby calculate all the definition addresses. The pre-loop analysis unit 122 determines whether each of all the definition addresses is included in the reference region identified by the beginning and end addresses of the reference item.

(S243) The pre-loop analysis unit 122 determines whether all the definition addresses are located outside the reference region. If all the definition addresses are located outside the reference region, the definition region and the reference region have no overlap. In this case, the process moves to step S246. On the other hand, if at least one of the definition addresses is located within the reference region, the process moves to step S244.

(S244) The pre-loop analysis unit 122 determines whether all the definition addresses are located within the reference region. If all the definition addresses are located within the reference region, the definition region and the reference region overlap in full. In this case, the process moves to step S246. On the other hand, if one or more of the definition addresses are located within the reference region and the remaining definition addresses are located outside the reference region, that is, if the definition region and the reference region overlap in part, the process moves to step S245.

(S245) The message display unit 124 generates the error message 91. The message display unit 124 displays the error message 91 on the display 111.

(S246) The pre-loop analysis unit 122 determines whether there is one or more unselected definition items in the parameters 83. If there is an unselected definition item, the process moves to step S241. If all the definition items in the parameters 83 have been selected, the process moves to step S247.

(S247) The pre-loop analysis unit 122 determines whether there is one or more unselected reference items in the parameters 82. If there is an unselected reference item, the process moves to step S240. If all the reference items in the parameters 82 have been selected, the analysis of regularly spaced-to-continuous regions ends.

FIG. 25 is a flowchart illustrating a procedure example of the analysis of regularly spaced-to-regularly spaced regions.

(S250) The pre-loop analysis unit 122 selects one definition item from the parameters 83 (parameters associated with regularly spaced region definitions).

(S251) The pre-loop analysis unit 122 selects one reference item from the parameters 84 (parameters associated with regularly spaced region references).

(S252) The pre-loop analysis unit 122 determines whether the overall range of the definition region from the beginning to the end overlaps the overall range of the reference region from the beginning to the end. For example, the pre-loop analysis unit 122 adds, to the beginning address of the definition item, the value obtained by multiplying the address step size of the definition item by (the number of iterations—1) to thereby calculate the end address. In addition, the pre-loop analysis unit 122 adds, to the beginning address of the reference item, the value obtained by multiplying the address step size of the reference item by (the number of iterations—1) to thereby calculate the end address. As in the case of the analysis of continuous-to-continuous regions, the pre-loop analysis unit 122 compares the overall range of the definition region with that of the reference region. If there is an overlap between them, the process moves to step S253. If not, the process moves to step S259.

(S253) The pre-loop analysis unit 122 determines whether the definition and reference items have matches in all the following three parameters: the beginning address; the number of iterations; and the address step size. If the definition and reference items have matches in all the three parameters, the definition region and the reference region overlap in full. In this case, the process moves to step S259. If the definition and reference items differ in at least one of the three parameters, the process moves to step S254.

(S254) The pre-loop analysis unit 122 determines whether the definition and reference items share the same beginning address. If the definition and reference items share the same beginning address, the process moves to step S257. Note that, in this case, the definition and reference items differ in at least one of the number of iterations and the address step size. If the definition and reference items have different beginning addresses, the process moves to step S255.

(S255) The pre-loop analysis unit 122 determines whether the definition and reference items have matches in both the number of iterations and the address step size. If the definition and reference items share the same number of iterations and address step size but differ in the beginning address, the process moves to step S256. On the other hand, if the definition and reference items differ in at least one of the number of iterations and the address step size in addition to the beginning address, the process moves to step S257.

(S256) The pre-loop analysis unit 122 calculates the difference between the beginning address of the definition item and that of the reference item, and determines whether the difference is an integral multiple of the address step size. If the definition and reference items share the same number of iterations and address step size and the difference in the beginning addresses is an integral multiple of the address step size, the definition and reference regions overlap in part. In this case, the process moves to step S258. On the other hand, if the definition and reference items share the same number of iterations and address step size but the difference in the beginning addresses is not an integral multiple of the address step size, the definition and reference regions have no overlap. In this case, the process moves to step S259.

(S257) The pre-loop analysis unit 122 calculates addresses (definition addresses) of individual regions to be accessed regularly based on the definition item. In addition, the pre-loop analysis unit 122 calculates addresses (reference addresses) of individual regions to be accessed regularly based on the reference item. The pre-loop analysis unit 122 exhaustively compares the definition addresses with the reference addresses to determine whether only some of the definition addresses and the reference addresses have matches with each other. If only some of the definition addresses and the reference addresses have matches with each other, the process moves to step S258. If none of the definition addresses have matches with the reference addresses or all the definition addresses have matches with the reference addresses, the process moves to step S259. Note here that, as for most of definition and reference items, the determination of whether to move to step S258 is made by the determination conditions of steps 5252 to 5256, and it is therefore less likely for step S257 to be executed.

(S258) The message display unit 124 generates the error message 91. The message display unit 124 displays the error message 91 on the display 111.

(S259) The pre-loop analysis unit 122 determines whether there is one or more unselected reference items in the parameters 84. If there is an unselected reference item, the process moves to step S251. If all the reference items in the parameters 84 have been selected, the process moves to step S260.

(S260) The pre-loop analysis unit 122 determines whether there is one or more unselected definition items in the parameters 83. If there is an unselected definition item, the process moves to step S250. If all the definition items in the parameters 83 have been selected, the analysis of regularly spaced-to-regularly spaced regions ends.

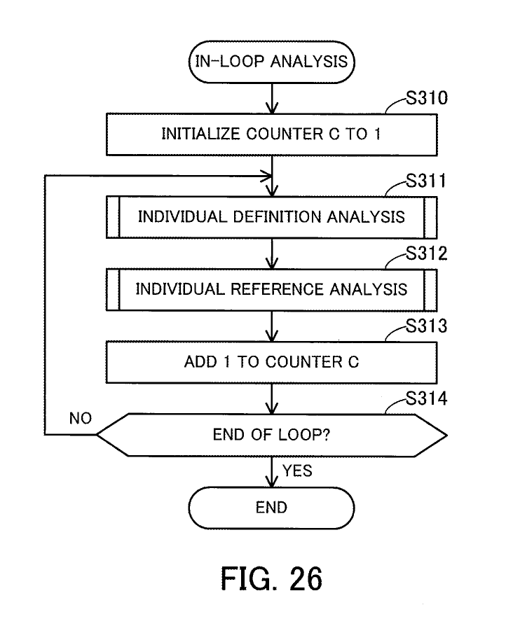

FIG. 26 is a flowchart illustrating a procedure example of the in-loop analysis.

(S310) Based on the object code generated by the compiling device 200, the parallel computing device 100 initializes the counter C to 1 prior to the execution of a loop.

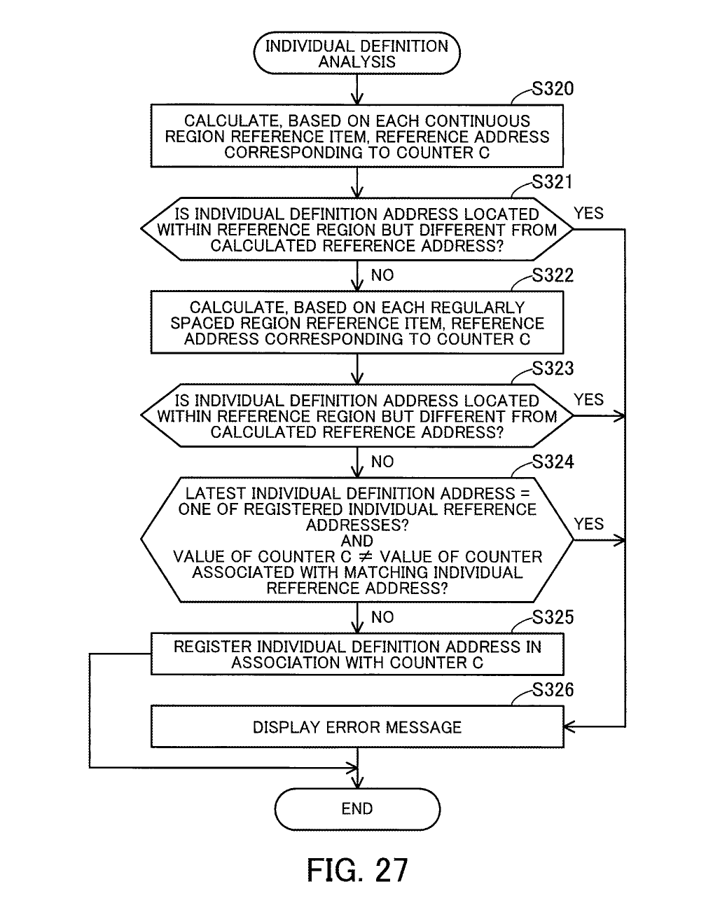

(S311) Based on the object code generated by the compiling device 200, the parallel computing device 100 calls the in-loop analysis unit 123 within the loop for each definition item not analyzed prior to the execution of the loop. The in-loop analysis unit 123 executes individual definition analysis. The “individual definition analysis” is explained below with reference to FIG. 27.

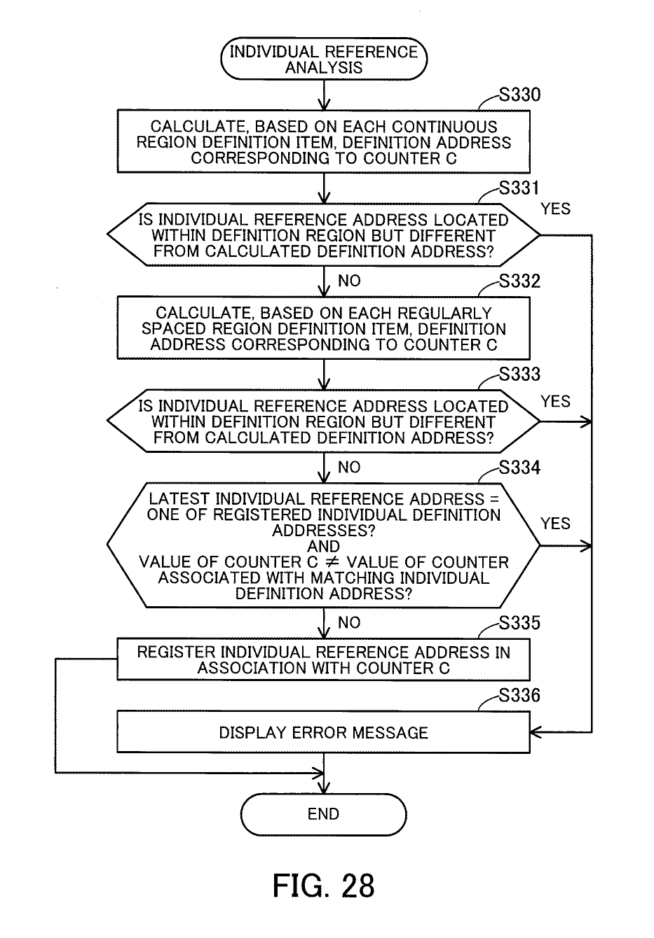

(S312) Based on the object code generated by the compiling device 200, the parallel computing device 100 calls the in-loop analysis unit 123 within the loop for each reference item not analyzed prior to the execution of the loop. The in-loop analysis unit 123 executes individual reference analysis. The “individual reference analysis” is explained below with reference to FIG. 28.

(S313) Based on the object code generated by the compiling device 200, the parallel computing device 100 adds 1 to the counter C.

(S314) Based on the object code generated by the compiling device 200, the parallel computing device 100 determines whether conditions for ending the loop have been met (for example, whether the value of the loop variable has reached its upper bound). If the conditions for ending the loop have been met, the in-loop analysis ends. On the other hand, if the conditions are not met, the process moves to step S311.

FIG. 27 is a flowchart illustrating a procedure example of the individual definition analysis.

(S320) Based on each reference item indicated by the parameters 82, the in-loop analysis unit 123 calculates a reference address corresponding to the current counter C, that is, an address of an element, within its continuous reference region, referenced when the value of the loop variable is the same as the current one.

(S321) The in-loop analysis unit 123 compares the address of an element defined when the in-loop analysis unit 123 was called (the latest individual definition address) against the continuous reference region indicated by the parameters 82. In addition, the in-loop analysis unit 123 compares the latest individual definition address against the reference address calculated in step S320. The in-loop analysis unit 123 determines whether the latest individual definition address is located within the continuous reference region and is then different from the reference address of step S320. If this condition is satisfied, the element indicated by the latest individual definition address is to be referenced in an iteration with the loop variable taking a different value (i.e., a different iteration of the loop). If the above condition is satisfied, the process moves to step S326. If not, the process moves to step S322.

(S322) Based on each reference item indicated by the parameters 84, the in-loop analysis unit 123 calculates a reference address corresponding to the current counter C, that is, an address of an element, within its collection of regularly spaced reference regions, referenced when the value of the loop variable is the same as the current one.

(S323) The in-loop analysis unit 123 compares the latest individual definition address against the regularly spaced reference regions indicated by the parameters 84. In addition, the in-loop analysis unit 123 compares the latest individual definition address against the reference address calculated in step S322. The in-loop analysis unit 123 determines whether the latest individual definition address is located within the regularly spaced reference regions and is then different from the reference address of step S322. If this condition is satisfied, the element indicated by the latest individual definition address is to be referenced in an iteration with the loop variable taking a different value. If the above condition is satisfied, the process moves to step S326. If not, the process moves to step S324.

(S324) The in-loop analysis 123 determines whether the latest individual definition address matches one of individual reference addresses registered in the address information storing unit 121. In addition, the in-loop analysis unit 123 determines whether the current counter C has a different value from that of a counter associated with the matching individual reference address. If these conditions are met, the process moves to step S326. If not, the process moves to step S325.

(S325) The in-loop analysis unit 123 registers, in the address information storage unit 121, the latest individual definition address in association with the current counter C.

(S326) The message display unit 124 generates the error message 91. The message display unit 124 displays the error message 91 on the display 111.

FIG. 28 is a flowchart illustrating a procedure example of the individual reference analysis.

(S330) Based on each definition item indicated by the parameters 81, the in-loop analysis unit 123 calculates a definition address corresponding to the current counter C, that is, an address of an element, within its continuous definition region, defined when the value of the loop variable is the same as the current one.

(S331) The in-loop analysis unit 123 compares the address of an element referenced when the in-loop analysis unit 123 was called (the latest individual reference address) against the continuous definition region indicated by the parameters 81. In addition, the in-loop analysis unit 123 compares the latest individual reference address against the definition address calculated in step S330. The in-loop analysis unit 123 determines whether the latest individual reference address is located within the continuous definition region and is then different from the definition address of step S330. If this condition is satisfied, the element indicated by the latest individual reference address is to be defined in an iteration with the loop variable taking a different value. If the above condition is satisfied, the process moves to step S336. If not, the process moves to step S332.

(S332) Based on each definition item indicated by the parameters 83, the in-loop analysis unit 123 calculates a definition address corresponding to the current counter C, that is, an address of an element, within its collection of regularly spaced definition regions, defined when the value of the loop variable is the same as the current one.

(S333) The in-loop analysis unit 123 compares the latest individual reference address against the regularly spaced definition regions indicated by the parameters 83. In addition, the in-loop analysis unit 123 compares the latest individual reference address with the definition address calculated in step S332. The in-loop analysis unit 123 determines whether the latest individual reference address is located within the regularly spaced definition regions and is then different from the definition address of step S332. If this condition is satisfied, the element indicated by the latest individual reference address is to be defined in an iteration with the loop variable taking a different value. If the above condition is satisfied, the process moves to step S336. If not, the process moves to step S334.

(S334) The in-loop analysis 123 determines whether the latest individual reference address matches one of individual definition addresses registered in the address information storing unit 121. In addition, the in-loop analysis unit 123 determines whether the current counter C has a different value from that of a counter associated with the matching individual definition address. If these conditions are met, the process moves to step S336. If not, the process moves to step S335.

(S335) The in-loop analysis unit 123 registers, in the address information storage unit 121, the latest individual reference address in association with the current counter C.

(S336) The message display unit 124 generates the error message 91. The message display unit 124 displays the error message 91 on the display 111.

According to the information processing system of the third embodiment, even if a definition region and a reference region depend on arguments, efficient comparison between the definition and reference regions prior to the execution of a loop is possible if each of the regions is either a continuous region or a collection of regularly spaced regions. Then, if the definition region and the reference region overlap in part, the loop is determined to be not parallelizable and the error message 91 is displayed.

Many definition and reference regions are expected to be continuous or a collection of regularly spaced regions. Therefore, it is less likely to determine whether a loop is parallelizable by comparing individual addresses within the loop. This raises the possibility of loop parallelizability in debug object code. As a result, the runtime of the debug object code is reduced. In addition, the need for exhaustively comparing addresses of accessed regions is eliminated, which reduces load on the parallel computing device 100. Thus, it is possible to efficiently detect, in source code, errors associated with loop parallelization (i.e., parallelization being instructed for loops which are not parallelizable).

Note that the information processing of the first embodiment is implemented by causing the parallel computing device 10 to execute a program, as described above. In addition, the information processing of the second embodiment is implemented by causing the compiling device 20 to execute a program. The information processing of the third embodiment is implemented by causing the parallel computing device 100 and the compiling device 200 to execute a program.

Such a program may be recorded in a computer-readable storage medium (for example, the storage media 113 and 213). Examples of such a computer-readable storage medium include a magnetic disk, an optical disk, a magneto-optical disk, and a semiconductor memory. Examples of the magnetic disk are a FD and a HDD. Examples of the optical disk are a compact disc (CD), CD-recordable (CD-R), CD-rewritable (CD-RW), DVD, DVD-R, and DVD-RW. The program may be recorded on each portable storage medium and then distributed. In such a case, the program may be executed after being copied from the portable storage medium to a different storage medium (for example, the HDDs 103 and 203).

According to one aspect, it is possible to efficiently detect programming errors associated with loop parallelization.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A parallel computing apparatus comprising:
a memory configured to store code including a loop which includes update processing for updating first elements of an array, indicated by a first index, and reference processing for referencing second elements of the array, indicated by a second index, at least one of the first index and the second index depending on a parameter whose value is determined at runtime; and
a processor configured to perform a procedure including:
calculating, based on the value of the parameter determined at runtime, a first range of the first elements to be updated in the array by the update processing and a second range of the second elements to be referenced in the array by the reference processing prior to execution of the loop after execution of the code has started, and
comparing the first range with the second range and outputting a warning indicating that the loop is not parallelizable when the first range and the second range overlap in part.

2. The parallel computing apparatus according to claim 1, wherein:
the procedure further includes determining that the loop is parallelizable when the first range and the second range overlap in full or have no overlap.

3. The parallel computing apparatus according to claim 1, wherein:
each of the first range and the second range is a set of consecutive or regularly spaced elements amongst a plurality of elements included in the array, and
the procedure further includes calculating, prior to the execution of the loop, the first range based on continuity or regularity of the first index and the second range based on continuity or regularity of the second index.

4. A parallel processing method comprising:
starting, by a processor, execution of code including a loop which includes update processing for updating first elements of an array, indicated by a first index, and reference processing for referencing second elements of the array, indicated by a second index, at least one of the first index and the second index depending on a parameter whose value is determined at runtime;
calculating, by the processor, based on the value of the parameter determined at runtime, a first range of the first elements to be updated in the array by the update processing and a second range of the second elements to be referenced in the array by the reference processing prior to executing the loop after having started execution of the code; and
comparing, by the processor, the first range with the second range and outputting a warning indicating that the loop is not parallelizable when the first range and the second range overlap in part.

5. A non-transitory computer-readable storage medium storing a computer program that causes a computer to perform a procedure comprising:
calculating, after start of execution of code including a loop, which includes update processing for updating first elements of an array, indicated by a first index, and reference processing for referencing second elements of the array, indicated by a second index, but prior to execution of the loop, a first range of the first elements to be updated in the array by the update processing and a second range of the second elements to be referenced in the array by the reference processing, based on a value of a parameter which value is determined at runtime, at least one of the first index and the second index depending on the parameter; and
comparing the first range with the second range and outputting a warning indicating that the loop is not parallelizable when the first range and the second range overlap in part.
